(19) United States
(12) Patent Application Publication
(10) Pub. No.: US 2026/0046187 A1
(43) Pub. Date: Feb. 12, 2026

(54) FREQUENCY MODULATED CONTINUOUS WAVE (FMCW) SYNCHRONIZATION SIGNAL TRANSMISSION AND DETECTION

(71) Applicant: QUALCOMM Incorporated, San Diego, CA (US)

(72) Inventors: Weimin DUAN, San Diego, CA (US); Jing SUN, San Diego, CA (US); Kangqi LIU, San Diego, CA (US); Gabi SARKIS, San Diego, CA (US)

(21) Appl. No.: 18/796,618

(22) Filed: Aug. 7, 2024

(51) Int. Cl. H04L 27/26; H04L 5/00; H04W 48/16

(52) U.S. Cl. CPC H04L 27/2663; H04L 5/0053; H04W 48/16

(57) ABSTRACT

Methods, systems, and devices for wireless communications are described. A network entity may transmit a pre-synchronization signal (SSB) signal using a low complexity waveform (e.g., a frequency modulated continuous wave (FMCW)). The UE may perform cell detection and coarse synchronization upon receiving FMCWs. The network entity may transmit FMCWs (e.g., pre-SSB FMCW transmissions) over a set of raster points in the frequency domain according to a first periodicity, and may transmit SSBs (e.g., including SSSs and a PBCH, but no PSS) at a second periodicity. The UE may perform FMCW burst detection procedures to receive the FMCWs. The UE may therefore perform low-complexity cell detection and synchronization without increasing resource expenditures by the network entity, resulting in efficient cell detection and synchronization, decreased power expenditures by the UE, decreased signaling overhead by the network entity, and improved user experience.

### FIELD OF TECHNOLOGY

The following relates to wireless communications, including frequency modulated continuous wave (FMCW) synchronization signal transmission and detection.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include monitoring, according to a searching procedure, for at least one of a first frequency modulated continuous wave (FMCW) of a set of multiple FMCWs, or a first synchronization signal block (SSB) burst of a set of multiple SSB bursts, the monitoring including sweeping across a set of multiple frequency resources during a first set of time resources according to a duration in time of each FMCW of the set of multiple FMCWs and a frequency range associated with each FMCW of the set of multiple FMCWs and receiving at least one of the first FMCW or the first SSB burst based on the monitoring.

A UE for wireless communications is described. The UE may include one or more memories storing processor executable code, and one or more processors coupled with the one or more memories. The one or more processors may individually or collectively be operable to execute the code to cause the UE to monitor, according to a searching procedure, for at least one of a first frequency modulated continuous wave (FMCW) of a set of multiple FMCWs, or a first synchronization signal block (SSB) burst of a set of multiple SSB bursts, the monitoring including sweeping across a set of multiple frequency resources during a first set of time resources according to a duration in time of each FMCW of the set of multiple FMCWs and a frequency range associated with each FMCW of the set of multiple FMCWs and receive at least one of the first FMCW or the first SSB burst based on the monitoring.

Another UE for wireless communications is described. The UE may include means for monitoring, according to a searching procedure, for at least one of a first frequency modulated continuous wave (FMCW) of a set of multiple FMCWs, or a first synchronization signal block (SSB) burst of a set of multiple SSB bursts, the monitoring including sweeping across a set of multiple frequency resources during a first set of time resources according to a duration in time of each FMCW of the set of multiple FMCWs and a frequency range associated with each FMCW of the set of multiple FMCWs and means for receiving at least one of the first FMCW or the first SSB burst based on the monitoring.

A non-transitory computer-readable medium storing code for wireless communications is described. The code may include instructions executable by one or more processors to monitor, according to a searching procedure, for at least one of a first FMCW of a set of multiple FMCWs, or a first SSB burst of a set of multiple SSB bursts, the monitoring including sweeping across a set of multiple frequency resources during a first set of time resources according to a duration in time of each FMCW of the set of multiple FMCWs and a frequency range associated with each FMCW of the set of multiple FMCWs and receive at least one of the first FMCW or the first SSB burst based on the monitoring.

Some examples of the method, UEs, and non-transitory computer-readable medium described herein may further include operations, features, means, or instructions for performing a primary synchronization based on receiving the first FMCW, receiving the first SSB burst based on the primary synchronization, and performing a secondary synchronization based on reception of the first SSB burst.

Some examples of the method, UEs, and non-transitory computer-readable medium described herein may further include operations, features, means, or instructions for performing an FMCW mixing procedure based on the monitoring to generate a beat signal and performing one or more Fast Fourier Transforms on the beat signal to identify one or more peak locations in a frequency domain, the one or more peak locations corresponding to the first FMCW.

Some examples of the method, UEs, and non-transitory computer-readable medium described herein may further include operations, features, means, or instructions for sweeping across the set of multiple frequency resources during a second set of time resources according to a slope value that may be based on the duration in time of each FMCW of the set of multiple FMCWs and the frequency range associated with each FMCW of the set of multiple FMCWs.

In some examples of the method, UEs, and non-transitory computer-readable medium described herein, receiving the first FMCW may include operations, features, means, or instructions for receiving a first instance of the first FMCW during the first set of time resources and receiving a second instance of the first FMCW during the second set of time resources.

Some examples of the method, UEs, and non-transitory computer-readable medium described herein may further include operations, features, means, or instructions for receiving a first portion of the first FMCW during the first set of time resources, adjusting a timing for monitoring for the set of multiple FMCWs, and sweeping across the set of multiple frequency resources during a second set of time resources according to a slope value that may be based on the duration in time of each FMCW of the set of multiple FMCWs and a frequency range associated with each FMCW of the set of multiple FMCWs, and based on the adjusted timing, where reception of the first FMCW may be based on sweeping the frequency resources during the second set of time resources.

In some examples of the method, UEs, and non-transitory computer-readable medium described herein, the set of multiple FMCWs may be transmitted at a first periodicity, and the set of multiple SSB bursts may be transmitted at a second periodicity.

Some examples of the method, UEs, and non-transitory computer-readable medium described herein may further include operations, features, means, or instructions for detecting, based on reception of the first FMCW, a timing of the set of multiple FMCWs and refraining from monitoring for a second FMCW, the first SSB burst, or both, for a time duration that may be based on the first periodicity, the second periodicity, a time offset between each FMCW of the set of multiple FMCWs and a next SSB burst of the set of multiple SSB bursts, or any combination thereof.

Some examples of the method, UEs, and non-transitory computer-readable medium described herein may further include operations, features, means, or instructions for detecting, based on the monitoring, multiple FMCW beat frequencies and identifying a unique pattern in time and frequency based on the detection, where reception of the first FMCW may be based on the identifying.

Some examples of the method, UEs, and non-transitory computer-readable medium described herein may further include operations, features, means, or instructions for detecting, based on the monitoring, a zero tail FMCW waveform having a duration that may be less than an orthogonal frequency division multiplexing symbol, where reception of the first FMCW may be based on the detection.

In some examples of the method, UEs, and non-transitory computer-readable medium described herein, the searching procedure includes a cell search procedure, a beam management procedure, a tracking loop procedure, or any combination thereof.

A method for wireless communication by a network entity is described. The method may include output a set of multiple frequency modulated continuous wave (FMCW) bursts via a first set of time resources and a first set of frequency resources, the first set of frequency resources corresponding to a first periodicity and the first set of frequency resources corresponding to at least a first raster point of a set of raster points in a frequency domain, the set of raster points indicating a set of multiple noncontiguous frequency resources of the first set of frequency resources and output a set of multiple synchronization signal block (SSB) bursts via a second set of time resources according to a second periodicity and via the first set of frequency resources.

A network entity for wireless communication is described. The network entity may include one or more memories storing processor executable code, and one or more processors coupled with the one or more memories. The one or more processors may individually or collectively be operable to execute the code to cause the network entity to output a set of multiple frequency modulated continuous wave (FMCW) bursts via a first set of time resources and a first set of frequency resources, the first set of frequency resources corresponding to a first periodicity and the first set of frequency resources corresponding to at least a first raster point of a set of raster points in a frequency domain, the set of raster points indicating a set of multiple noncontiguous frequency resources of the first set of frequency resources and output a set of multiple synchronization signal block (SSB) bursts via a second set of time resources according to a second periodicity and via the first set of frequency resources.

Another network entity for wireless communication is described. The network entity may include means for output a set of multiple frequency modulated continuous wave (FMCW) bursts via a first set of time resources and a first set of frequency resources, the first set of frequency resources corresponding to a first periodicity and the first set of frequency resources corresponding to at least a first raster point of a set of raster points in a frequency domain, the set of raster points indicating a set of multiple noncontiguous frequency resources of the first set of frequency resources and means for output a set of multiple synchronization signal block (SSB) bursts via a second set of time resources according to a second periodicity and via the first set of frequency resources.

A non-transitory computer-readable medium storing code for wireless communication is described. The code may include instructions executable by one or more processors to output a set of multiple FMCW bursts via a first set of time resources and a first set of frequency resources, the first set of frequency resources corresponding to a first periodicity and the first set of frequency resources corresponding to at least a first raster point of a set of raster points in a frequency domain, the set of raster points indicating a set of multiple noncontiguous frequency resources of the first set of frequency resources and output a set of multiple synchronization signal block (SSB) bursts via a second set of time resources according to a second periodicity and via the first set of frequency resources.

Some examples of the method, network entities, and non-transitory computer-readable medium described herein may further include operations, features, means, or instructions for generating a set of multiple FMCW chirps via the first set of time resources, the set of multiple FMCW chirps corresponding to a slope value indicating a change in frequency over time, where outputting the set of multiple FMCW bursts may be based on outputting the set of multiple FMCW chirps.

In some examples of the method, network entities, and non-transitory computer-readable medium described herein, each of the set of multiple FMCW bursts including one or more of the set of multiple FMCW chirps correspond to two separated FMCW beat frequencies and a unique pattern in time and frequency.

In some examples of the method, network entities, and non-transitory computer-readable medium described herein, an FMCW duration in each time resource of the first set of time resources may be less than a symbol duration, and an unoccupied portion of each time resources of the first set of time resources may be equal to a cyclic prefix length.

In some examples of the method, network entities, and non-transitory computer-readable medium described herein, an FMCW duration in each time resource of the first set of time resources may be less than a symbol duration, and an unoccupied portion of each time resources of the first set of time resources may be greater than a cyclic prefix length.

In some examples of the method, network entities, and non-transitory computer-readable medium described herein, the first periodicity may be equal to the second periodicity.

In some examples of the method, network entities, and non-transitory computer-readable medium described herein, the first periodicity may be greater than the second periodicity.

In some examples of the method, network entities, and non-transitory computer-readable medium described herein, the first periodicity may be smaller than the second periodicity.

In some examples of the method, network entities, and non-transitory computer-readable medium described herein, an offset value indicates an offset between each respective FMCW burst of the set of multiple FMCW bursts and a next SSB burst of the set of multiple SSB bursts.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports frequency modulated continuous wave (FMCW) synchronization signal transmission and detection in accordance with one or more aspects of the present disclosure.

FIG. 2 shows an example of a wireless communications system that supports FMCW synchronization signal transmission and detection in accordance with one or more aspects of the present disclosure.

FIG. 3 shows an example of timelines that supports FMCW synchronization signal transmission and detection in accordance with one or more aspects of the present disclosure.

FIG. 4 shows an example of an FMCW signaling scheme that supports FMCW synchronization signal transmission and detection in accordance with one or more aspects of the present disclosure.

FIG. 5 shows an example of an FMCW detection procedure that supports FMCW synchronization signal transmission and detection in accordance with one or more aspects of the present disclosure.

FIG. 6 shows an example of an FMCW detection procedure that supports FMCW synchronization signal transmission and detection in accordance with one or more aspects of the present disclosure.

FIG. 7 shows an example of a process flow that supports FMCW synchronization signal transmission and detection in accordance with one or more aspects of the present disclosure.

FIGS. 8 and 9 show block diagrams of devices that support FMCW synchronization signal transmission and detection in accordance with one or more aspects of the present disclosure.

FIG. 10 shows a block diagram of a communications manager that supports FMCW synchronization signal transmission and detection in accordance with one or more aspects of the present disclosure.

FIG. 11 shows a diagram of a system including a device that supports FMCW synchronization signal transmission and detection in accordance with one or more aspects of the present disclosure.

FIGS. 12 and 13 show block diagrams of devices that support FMCW synchronization signal transmission and detection in accordance with one or more aspects of the present disclosure.

FIG. 14 shows a block diagram of a communications manager that supports FMCW synchronization signal transmission and detection in accordance with one or more aspects of the present disclosure.

FIG. 15 shows a diagram of a system including a device that supports FMCW synchronization signal transmission and detection in accordance with one or more aspects of the present disclosure.

FIGS. 16 through 19 show flowcharts illustrating methods that support FMCW synchronization signal transmission and detection in accordance with one or more aspects of the present disclosure.

### DETAILED DESCRIPTION

In some examples, a wireless device (e.g., a user equipment (UE)) may perform operations such as cell search and discovery, beam management, tracking loop procedures, etc. The network entity may transmit synchronization information (e.g., a synchronization signal block (SSB), including a primary synchronization signal (PSS), secondary synchronization signal (SSS), and a physical broadcast channel (PBCH)). The UE may monitor for and receive these signals to perform coarse synchronization (e.g., based on the PSS) and finer synchronization (e.g., using the SSS). However, some UEs may not have wideband processing capability, or may expend computational resources to perform wideband processing.

In some examples, as described herein, the network entity may transmit a pre-SSB signal using a low complexity waveform (e.g., a frequency modulated continuous wave (FMCW)). For instance, the FMCW waveform may include (e.g., or may serve as) a PSS, and the UE may perform cell detection and coarse synchronization upon receiving FMCW bursts (e.g., using a correlation-based detector, with the same sequence length, resulting in detection performance that is not negatively impacted by use of the FMCW bursts instead of other sequences). The network entity may transmit FMCW bursts (e.g., pre-SSB FMCW transmissions) over a set of raster points in the frequency domain according to a first periodicity, and may transmit SSBs (e.g., including SSSs and a PBCH, but no PSS) at a second periodicity. The UE may perform FMCW burst detection procedures to receive the FMCW bursts. The UE may therefore perform low-complexity cell detection and synchronization without increasing resource expenditures by the network entity, resulting in efficient cell detection and synchronization, decreased power expenditures by the UE, decreased signaling overhead by the network entity, and improved user experience.

Aspects of the disclosure are initially described in the context of wireless communications systems. Aspects of the disclosure are further illustrated by and described with reference to wireless communications systems, timelines, FMCW signaling schemes, FMCW detection procedures, and process flows. Aspects of the disclosure are further illustrated by and described with reference to apparatus diagrams, system diagrams, and flowcharts that relate to FMCW synchronization signal transmission and detection.

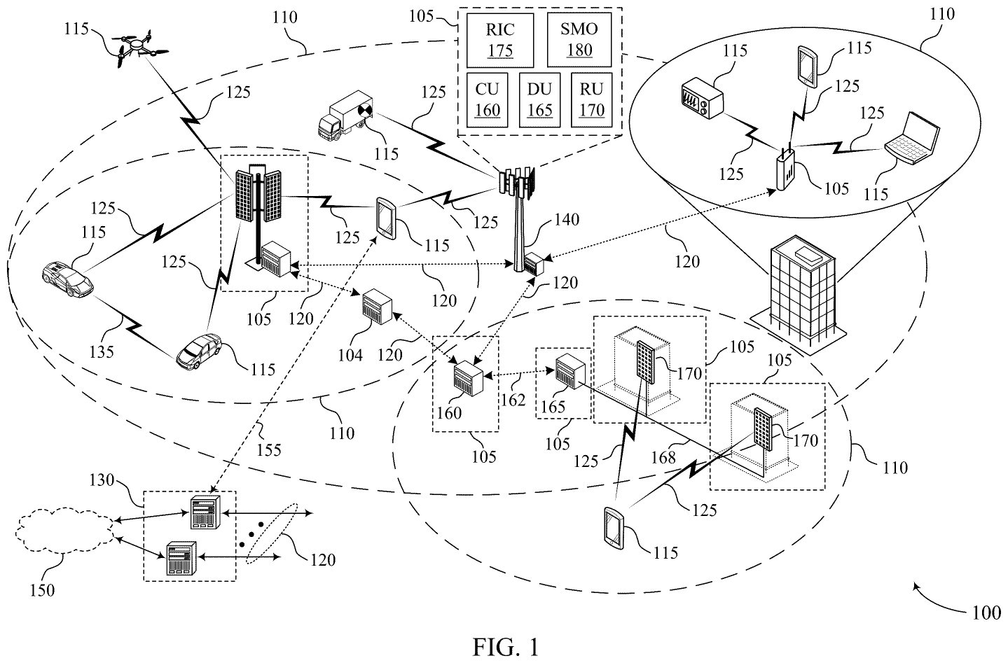

FIG. 1 shows an example of a wireless communications system 100 that supports frequency modulated continuous wave synchronization signal transmission and detection in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, as described herein, the network entity 105 may transmit a pre-SSB signal using a low complexity waveform (e.g., an FMCW)). For instance, the FMCW waveform may include (e.g., or may serve as) a PSS, and the UE 115 may perform cell detection and coarse synchronization upon receiving FMCW bursts (e.g., using a correlation-based detector, with the same sequence length, resulting in detection performance that is not negatively impacted by use of the FMCW bursts instead of other sequences). The network entity 105 may transmit FMCW bursts (e.g., pre-SSB FMCW transmissions) over a set of raster points in the frequency domain according to a first periodicity, and may transmit SSBs (e.g., including SSSs and a PBCH, but no PSS) at a second periodicity. The UE 115 may perform FMCW detection procedures to receive the FMCW. The UE 115 may therefore perform low-complexity cell detection and synchronization without increasing resource expenditures by the network entity, resulting in efficient cell detection and synchronization, decreased power expenditures by the UE 115, decreased signaling overhead by the network entity, and improved user experience.

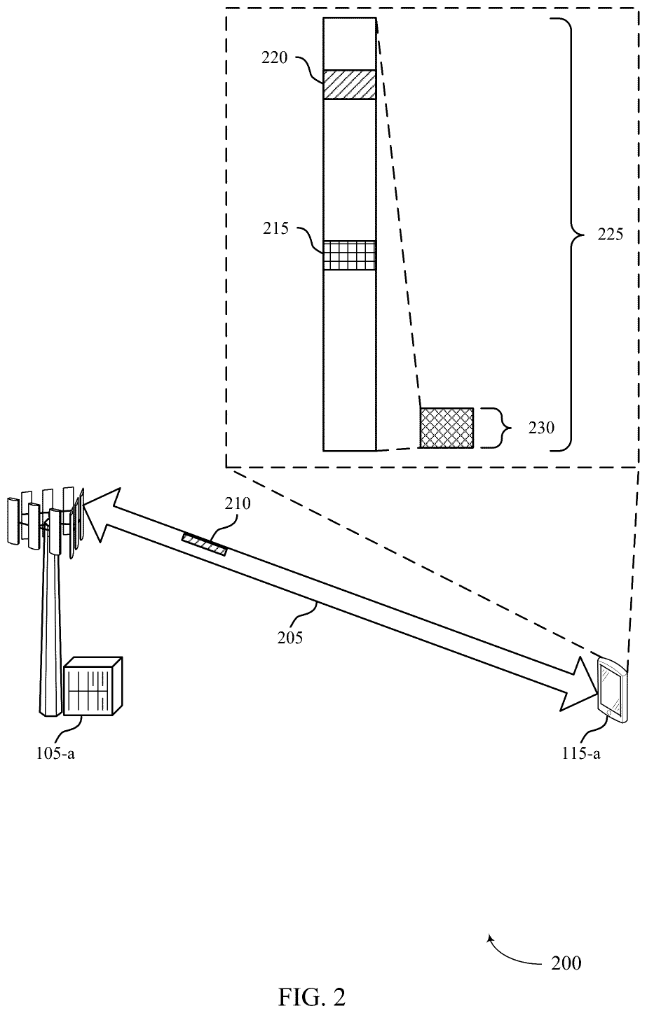

FIG. 2 shows an example of a wireless communications system 200 that supports FMCW synchronization signal transmission and detection in accordance with one or more aspects of the present disclosure. The wireless communications system 200 may implement, or be implemented by, aspects of the wireless communications system 100. For example, the network entity 105 may include a network entity 105-a, and a UE 115-a, which may be examples of corresponding devices described with reference to FIG. 1.

For example, the wireless communications system 200 may include one or more network entities 105 (e.g., a network entity 105-a) and one or more UEs 115 (e.g., a UE 115-a), which may be examples of the corresponding devices described with reference to FIG. 1. In some examples, a first wireless device transmitting a signal, which may be referred to herein as a “transmitting device” or “transmitter device,” and a second wireless device receiving a signal, which may be referred to herein as a “receiving device” or “receiver device,” may communicate via FMCW signaling 210 via a wireless channel 205. The FMCW signaling 210 may be used to facilitate an estimation of the channel 205 by the receiving device or may indicate communication information. In some examples, the transmitting device may be an example of a network entity 105-a and the receiving device may be an example of a UE 115-a. Additionally, or alternatively, a UE 115 may operate as a transmitting device as described herein, a network entity 105 may operate as a receiving device as described herein, or both. In some examples, the transmitting device, the receiving device, or both may include a transmitter, a receiver, a transceiver, or some combination thereof that perform the signaling described herein.

In some examples, a transmitting device (e.g., the network entity 105-a) may transmit FMCW signaling 210. An FMCW waveform may be a signal where frequency increase over time linearly (e.g., an up-chirp) or decreases over time linearly (e.g., a down-chirp). For instance, over a time T an FMCW burst may increase across a bandwidth (BW) of a carrier from

$$\frac{- BW}{2}$$

to BW/2 across the carrier. Processing of FMCW signaling 210 may be low cost (e.g., energy efficient, time efficient, power efficient, etc.). For example, a receiving device (e.g., the UE 115-a) may receive the signal, and the received signal may be mixed with a transmitted FMCW to generate a narrowband beat signal. Each beat signal frequency (e.g., fb) may map to a specific target reflection.

The transmitting device (e.g., the network entity 105-a) may utilize a voltage controlled oscillator (VCO) to perform the FMCW signal generation. The network entity 105-a may generate the FMCW burst (e.g., in an analog domain) using the VCO. The analog domain FMCW burst generated and transmitted by the network entity 105-a may be represented by x_{RF,Tx}(t), shown in Equation 1.

$${x}_{RF , Tx} ( t ) = cos ( 2 π ( {f}_{c} + \frac{S}{2} t ) t + {ϕ}_{Tx} ) \qquad ( 1 )$$

As shown in Equation 1, the FMCW may be a time-domain signal (e.g., a function of time (t)). In Equation 1, f_{c} may represent a starting frequency of the FMCW, S may represent a slope of the FMCW, and ϕ_{Tx} may represent a phase of the transmitting device 205-a (e.g., a gNB or some other network node).

The FMCW burst may be associated with a waveform signal transmitted via a duration (e.g., a duration of an OFDM symbol of an OFDM channel) in the time domain and a bandwidth (e.g., BW) in the frequency domain. The FMCW burst may span frequencies between the starting frequency f_{c} and a sum of the starting frequency and the bandwidth (e.g., {f_{c}, f_{c}+BW}). The transmit frequency may increase with time (e.g., f_{TX}(t)=f_{c}+St). That is, the slope, S, of the FMCW burst may correspond to a quotient of the bandwidth and a duration of the symbol via which the FMCW burst is transmitted, as shown by Equation 2.

$$S = \frac{BW}{{T}_{sym}} = \frac{{N}_{RE} \cdot Δ f}{{T}_{sym}} \qquad ( 2 )$$

In Equation 2, T_{sym} may represent the duration of the symbol, N_{RE} may represent a quantity of resource elements in the bandwidth, and Δf may represent a subcarrier spacing (SCS).

The FMCW burst may be received by the receiving device (e.g., the UE 115-a). The FMCW burst received at the UE 115-a may be represented by y_{RF, Rx}(t), shown in Equation 3.

$${y}_{RF , Rx} ( t ) = {\sum }_{p = 0}^{P - 1} {A}_{p} {x}_{RF , Tx} ( t - {τ}_{p} ) + n ( t ) \qquad ( 3 )$$

For the FMCW burst that is received by the UE, P may represent a quantity of channel delay paths (e.g., a quantity of multi-paths) associated with a channel 205 between the network entity 105-a and the UE 115-a, and τₚ may represent a given channel delay with index p. That is, the received FMCW signaling 210 may be sampled over various channel delays (e.g., p=0 to P−1). Aₚ may represent a complex gain of a given path p, and n(t) may represent channel noise.

The UE 115-a may generate an FMCW signal, which may be referred to as a second FMCW signal or a local FMCW signal. The UE 115-a may generate the FMCW signal in the analog domain using a VCO. The UE 115-a may generate the FMCW signal at the same time as or after receiving the FMCW burst. The FMCW signal generated by the UE 115-a may be represented by x_{RF,Rx}(t), shown in Equation 4.

$${x}_{RF , Rx} ( t ) = exp ( - j ( 2 π ( {f}_{c} + \frac{S}{2} t ) t + {ϕ}_{Rx} ) ) \qquad ( 4 )$$

The FMCW signal generated by the UE 115-a may have a same starting frequency and slope as the FMCW signal generated by the network entity 105-a. In Equation 4, ϕ_{Rx} may represent a phase of the UE 115-a. In some aspects, the phase of the UE 115-a may be the same as the phase of the network entity 105-a (e.g., ϕ_{Tx}=ϕ_{Rx}).

After generating the FMCW signal, the UE 115-a may generate a combined FMCW signal (e.g., y_{mixed}(t)). To generate the combined FMCW signal, the UE 115-a may combine the FMCW signal received with the locally generated FMCW signal using a mixer. The mixer may represent one or more components (e.g., hardware, software, or both) of the UE 115-a that are configured to combine two or more time-domain FMCW signals. In some aspects, the combining may include multiplying the FMCW signals (e.g., y_{mixed}(t)=y_{RF,Rx}(t) x_{RF,Rx}(t)).

The UE 115-a may filter the combined FMCW signal using a low pass filter (LPF). The LPF may generate a combined and filtered FMCW signal (e.g., y_{mixed,LPF}(t)). The LPF may represent a component of the UE 115-a that is configured to filter signals, or a function supported by the UE 115-a, or both. The combined and filtered FMCW signaling 210 may be represented by Equation 5.

$${y}_{mixed , LPF} ( t ) = {\sum }_{p = 0}^{P - 1} {β}_{p} exp ( - j 2 π S {τ}_{p} \cdot t ) , where \qquad ( 5 )$$

$${β}_{p} = \frac{{A}_{p}}{2} exp ( - j ( 2 π {f}_{c} {τ}_{p} ) ) exp ( j ( 2 π ( \frac{S}{2} {τ}_{p} ) {τ}_{p} - {ϕ}_{Rx} + {ϕ}_{Tx} ) )$$

After combining and filtering the FMCW signals, the UE 115-a may perform baseband sensing processing using the combined and filtered FMCW signal. In some aspects, the baseband sensing processing include using an ADC or other component of the UE 115-a to sample the combined and filtered FMCW signal in the time domain. A sampling rate used to sample the combined and filtered FMCW signal may be Fₛ.

The sampling by the UE 115-a as part of the baseband sensing processing may produce a sampling sequence, D_{Rx}(k), which may represent a set of values associated with the channel estimation.

The use of FMCW signaling 210 may support wideband sensing and channel estimation using narrowband processing. For instance, a low-speed ADC may sample beat signals, resulting in effective wideband sensing and channel estimation at lower cost and higher efficiently (e.g., lower power expenditures, more efficient use of computational resources at the UE 115-a, increased power savings, etc.). Accordingly, a wideband signal may be input into the mixer with the local FMCW signal, but an output of the LPF may correspond to a narrowband signal.

In some cases, the UE 115-a may estimate (e.g., measure) the channel 205 (e.g., an OFDM channel or other channel) based on one or more received signals to improve reliability and throughput of transmissions and receptions by the UE 115-a. In some examples, the UE 115-a may support a narrowband baseband processing capability 230. The UE 115-a may communicate via the channel 205 using a first bandwidth part (BWP) 215 (e.g., associated with a narrowband bandwidth in accordance with the UE's narrowband baseband processing capability 230), where the first BWP 215 is from a set of BWPs associated with a wideband channel 225. For example, the first BWP 215 may be a subset of a whole channel bandwidth supported by the network entity 105-a.

In some cases, a second BWP 220 associated with the wideband channel 225 (e.g., within a channel bandwidth) may be allocated for other purposes (e.g., for spectrum allocation or multiplexing for multiple wireless devices). In some such cases, the UE 115-a may measure the channel 205 (e.g., perform a channel estimation procedure) using one or more signals to estimate channel metrics for the wideband channel 225 (e.g., to determine channel metrics for both the first BWP 215 and the second BWP 220, to determine a preferred sub-band within the channel bandwidth).

In some examples, a UE 115 receiving signaling via the first BWP 215 may be unable to measure the channel 205 for the second BWP 220 due to an inability to receive one or more signals via the second BWP 220. For example, the UE may fail to estimate the channel 205 over the entire channel bandwidth for the wideband channel 225. In some other cases, such a UE may implement frequency hopping to estimate the channel 205 for the second BWP 220, receiving signaling via the first BWP 215 to estimate the channel for the first BWP 215 and hopping to receive the signaling via the second BWP 220 to estimate the channel for the second BWP 220. In some examples, the channel 205 via the first BWP 215 may be associated with relatively lower channel quality metrics than the channel via the second BWP 220. However, the UE may be unaware that the channel 205 via the second BWP 220 is associated with a relatively higher channel quality due to the UE's inability to measure the channel 205 via the second BWP 220 or due to a delay associated with measuring the channel 205 via the second BWP 220 due to frequency hopping. In some cases, such a UE may continue to communicate via the first BWP 215 instead of the second BWP 220, which may potentially result in reduced communication performance.

The wireless communications system 200 may support an FMCW-based channel estimation, such that the UE 115-a may perform channel estimation for the wideband channel 225 using narrowband baseband signaling (e.g., via the first BWP 215), for example, based on the narrowband baseband processing capability 230 of the UE 115-a. The UE 115-a may select a BWP for communications based on the FMCW-based channel estimation.

In some cases, the UE 115-a supporting the narrowband baseband processing capability 230 may not be able to estimate the channel 205 over the entire bandwidth (e.g., an entire wideband channel 225). However, using FMCW-based wideband channel sounding reference signals, the UE 115-a may be able to estimate the channel 205 over the entire bandwidth using narrowband baseband processing (e.g., in one shot). The whole bandwidth channel may be extracted from the narrowband baseband information. Such techniques may be utilized in one or more deployments including ultra-wide system bandwidths, and based on UE capabilities. The UE 115-a may therefore be able to scan a larger bandwidth to identity preferred subbands, while the network resource efficiency for UE-specific narrowband BWP allocation is improved at the network entity 105-a.

According to techniques described herein, the wireless communications system 200 may support FMCW signaling for synchronization and cell discovery, etc. For example, some wireless communications systems may support sparse cell discovery signaling (e.g., which may be referred to as pre-SSB signaling). In such examples, a periodicity for synchronization signal block (SSB) signaling may be increased (e.g., increasing system efficiency, but making SSB detection more difficult or delayed for UEs 115). Cell search procedures by the UE 115-a may expend power and may be complex. The UE 115-a may rely on synchronization signals (e.g., a PSS, a SSS, etc.) to perform cell search and establish connections with detected cells. For example, a pre-SSB signal may include a synchronization signal (e.g., a PSS) for cell discovery and coarse synchronization. A subsequent signal (e.g., an SSB) may include additional synchronization signals (e.g., SSS) for finer synchronization and other procedures. A PSS may utilize a pseudo-random sequence with a correlation-based detector. The correlation-based detector may rely on exhausted time domain sampling by sample search, but may also rely on wideband operation at the front-end of a receiver (e.g., the UE 115-a), which may result in increased complexity and power consumption by the UE 115-a.

Techniques described herein may support cell discovery and synchronization based on FMCW-based pre-SSB signals, which may support wide-band detection, low detection complexity and power expenditure at the UE 115-a, decreased signaling overhead without substantial negative impact to cell discovery, decreased system latency, decreased power expenditures, and improved user experience.

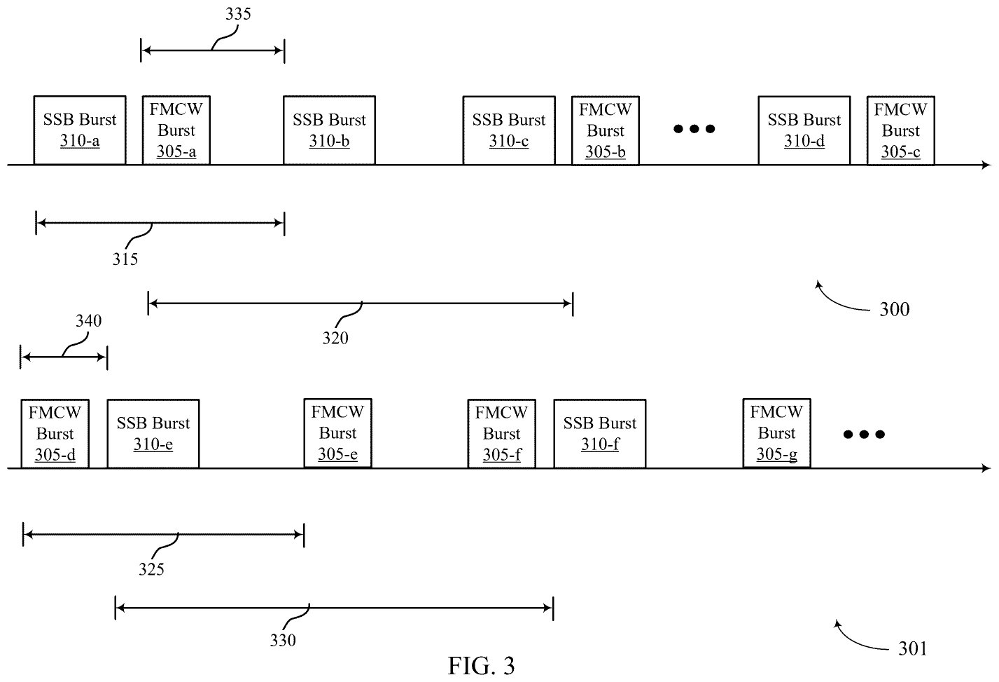

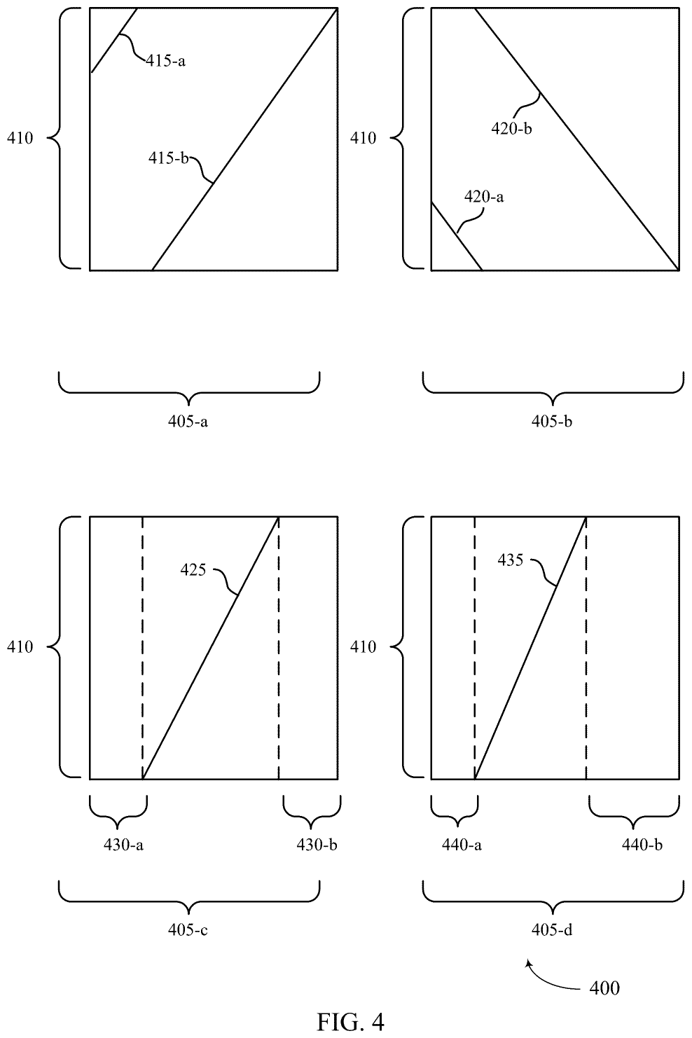

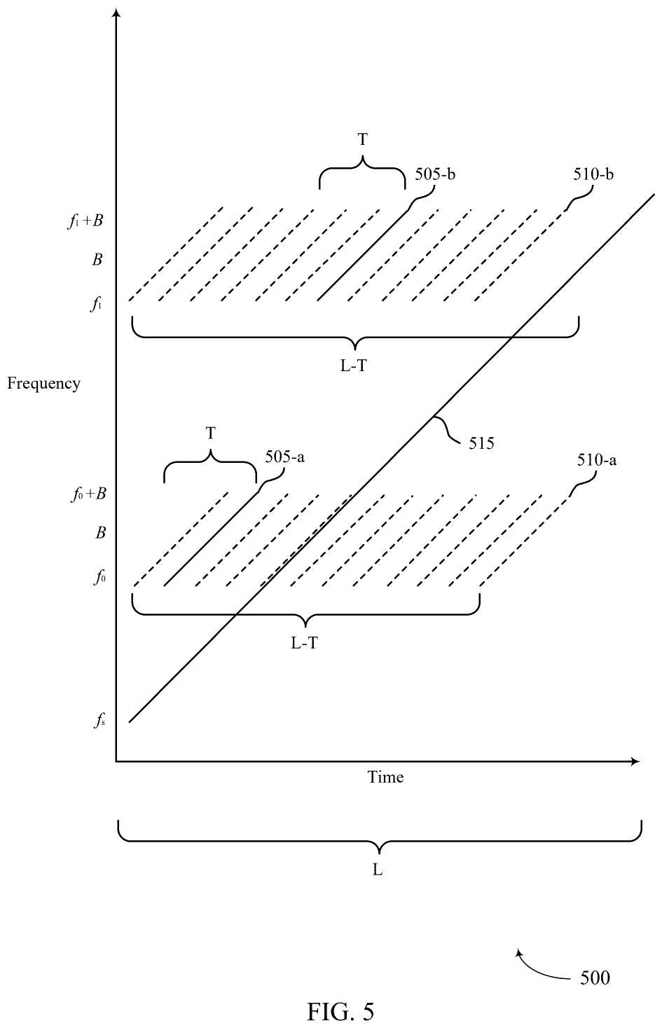

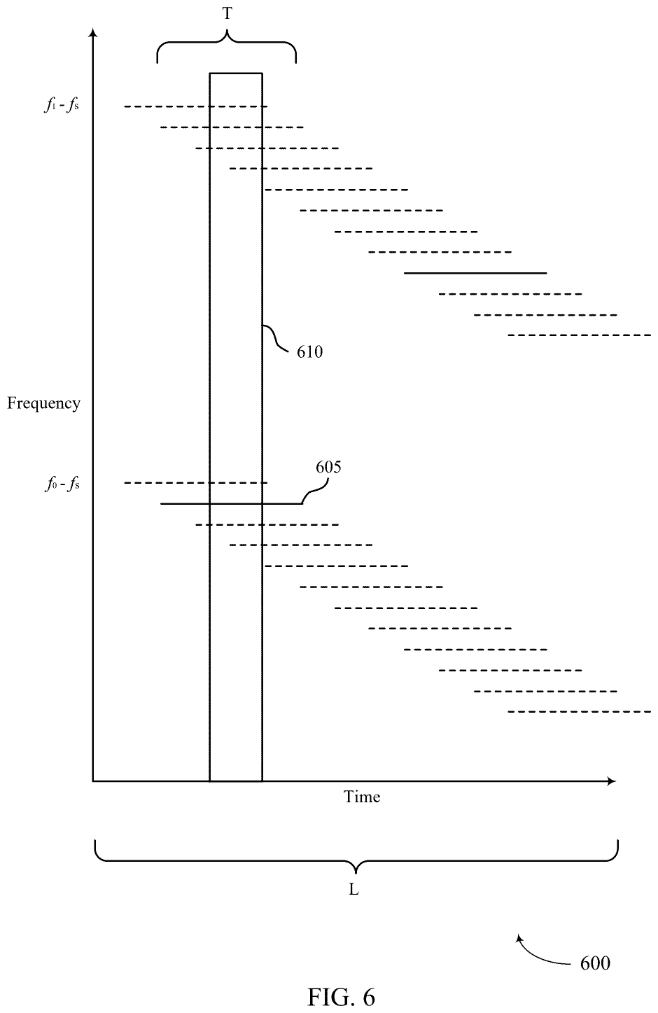

The UE 115-a may rely on FMCW signaling 210 to search cells (e.g., at potential synchronization raster points in the frequency domain) to get initial synchronization with a discovered cell. The FMCW waveform (e.g., instead of an m-sequence) may result in low detection complexity for the UE 115-a, and decreased signaling overhead by the network entity 105-a. The FMCW waveform may include (e.g., or may serve as) a PSS, and the UE 115-a may perform cell detection and coarse synchronization upon receiving FMCWs (e.g., using a correlation-based detector, with the same sequence length, resulting in detection performance that is not negatively impacted by use of the FMCW bursts instead of other sequences). The network entity 105-a may transmit FMCW bursts (e.g., pre-SSB FMCW transmissions) over a set of raster points in the frequency domain according to a first periodicity, and may transmit SSBs (e.g., including SSS and physical broadcast channel (PBCH), but no PSS) at a second periodicity, as described in greater detail with reference to FIG. 3 and FIG. 4. The UE 115-a may perform FMCW burst detection procedures to receive the FMCW bursts, as described in greater detail with reference to FIG. 5 and FIG. 6. The UE 115-a may therefore perform low-complexity cell detection and synchronization without increasing resource expenditures by the network entity 105-a, resulting in efficient cell detection and synchronization, decreased power expenditures by the UE 115-a, decreased signaling overhead by the network entity 105-a, and improved user experience.

FIG. 3 shows an example of a timeline 300 and a timeline 301 that support FMCW synchronization signal transmission and detection in accordance with one or more aspects of the present disclosure. The timeline 300 and the timeline 301 may implement, or be implemented by, aspects of the wireless communications system 100 and the wireless communications system 200. For example, one or more wireless devices (e.g., a network entity and a UE), which may be examples of corresponding devices described with reference to FIG. 1, may communicate according to the timeline 300, the timeline 301, or both.

The network entity may transmit pre-SSB signaling (e.g., FMCW signaling, such as FMCW bursts 305) over a set of raster points (e.g., in the frequency domain). For example, the network entity may transmit at a single raster point for each cell of multiple cells. The pre-SSB FMCW signaling may have a comparable bandwidth with a PSS in an SSB. If the pre-SSB FMCW signaling (e.g., the FMCW bursts 305) is used for cell searching, then SSBs 310 may include SSSs and PBCH signals (e.g., but no PSSs). In such examples, the total resource overhead for the pre-SSB FMCW bursts 305 and the SSB bursts 310 may not be higher than that of SSB signaling (e.g., where SSBs include PSS, SSS, and PBCH). However, the pre-SSB FMCW bursts 305 and the SSB bursts 310 may support lower complexity reception and increased power saving at the UE.

The pre-SSB FMCW may be an always on signal, which may be transmitted with a lower density or a higher density compared with SSB transmissions. For example, the SSBs 310 and the FMCW bursts 305 may be transmitted by the network entity according to equal periodicities (e.g., the periodicity of the SSBs and the FMCWs is the same, which is not illustrated with reference to FIG. 3).

In some examples, as illustrated with reference to the timeline 300, the FMCW bursts 305 may be transmitted according to a larger periodicity than the SSB bursts 310. For example, the SSB bursts 310 (e.g., the SSB burst 310-a, the SSB burst 310-b, the SSB burst 310-c, and the SSB burst 310-d) may be transmitted periodically according to a first periodicity 315 (e.g., 20 ms), and the FMCW bursts 305 (e.g., the FMCW burst 305-a, the FMCW burst 305-b, and the FMCW burst 305-c) may be transmitted periodically according to a second periodicity 320 (e.g., 40 ms). The periodicity 320 for the pre-SSB FMCW bursts 305 may be larger than the periodicity 315 for the SSB bursts 310 (e.g., if the SSBs are transmitted with a regular periodicity, which may or may not be the case). In some such examples, where the periodicity 320 is larger than the periodicity 315, one or more UEs may (e.g., primarily) use or rely on the FMCW signaling for initial cell search procedures (e.g., to support initial cell search procedures, the network entity may transmit the FMCW bursts 305 according to a larger periodicity than the SSB bursts 310).

In some examples, as illustrated with reference to the timeline 301, the FMCW bursts 305 may be transmitted according to a smaller periodicity than the SSB bursts 310. For example, the FMCW bursts 305 (e.g., the FMCW burst 305-d, the FMCW burst 305-c, the FMCW burst 305-f, and the FMCW burst 305-g) may be transmitted periodically according to a first periodicity 325 (e.g., 20 ms), and the SSB bursts 310 (e.g., the SSB burst 310-c, and the SSB burst 310-f) may be transmitted periodically according to a second periodicity 330 (e.g., 40 ms). The periodicity 325 for the pre-SSB FMCW bursts 305 may be smaller than the periodicity 330 for the SSB bursts 310 (e.g., if the SSBs are transmitted with a larger periodicity, which may or may not be the case). In some such examples, where the periodicity 325 is smaller than the periodicity 330, one or more UEs may use or rely on the FMCW signaling for enhanced tracking loops, beam management, when the network enters a network power saving mode, or the like. For instance, to support tracking loops or beam management, the network entity may transmit the FMCW bursts 305 according to a smaller periodicity than the SSB bursts 310).

The network entity may transmit the FMCW bursts according to the frequency raster points (e.g., fᵢ). The frequency raster points of an FMCW bursts 305 and an SSB burst 310 may be the same. The UE may assume that each of the FMCW bursts 305 and the SSB bursts 310 may occur according to a same frequency offset. In some examples, a timing offsets between FMCW bursts 305 and SSB bursts 310 may be defined (e.g., in one or more standards documents, indicated in pre-configuration, or configured at the UE, among other examples). Upon detection of the timing of the pre-SSB signaling (e.g., a timing or periodicity of the FMCW bursts 305), the UE may stop searching until a timing offset expires. For example, as illustrated with reference to the timeline 300, the network entity may transmit the SSB bursts 310 and the FMCW bursts 305 according to an SSB periodicity 315 (e.g., 20 ms), an FMCW burst periodicity 320 (e.g., 40 ms), and a timing offset 335 between the FMCW burst 305-a and the next SSB burst 310-b. The UE may detect a timing of the pre-SSB signaling (e.g., may detect the FMCW burst 305-a). The UE may search for the SSB (e.g., the SSB burst 310-b) at T+10+k*min {40, 20} ms, where T represents the pre-SSB timing point. Similarly, as illustrated with reference to the timeline 301, the network entity may transmit the SSB bursts 310 and the FMCW bursts 305 according to an SSB periodicity 330 (e.g., 40 ms), an FMCW burst periodicity 325 (e.g., 20 ms), and a timing offset 340 between the FMCW burst 305-d and the next SSB burst 310-e. The UE may detect a timing of the pre-SSB signaling (e.g., may detect the FMCW burst 305-d). The UE may search for the SSB (e.g., the SSB burst 310-b) at T+5+k*min {20, 40} ms, where T represents the pre-SSB timing point.

FIG. 4 shows an example of a FMCW signaling scheme 400 that supports FMCW synchronization signal transmission and detection in accordance with one or more aspects of the present disclosure. The FMCW scheme 400 may implement, or be implemented by, aspects of the wireless communications system 100, the wireless communications system 200, and the timeline 300, and the timeline 301. For example, one or more wireless devices (e.g., a network entity and a UE), which may be examples of corresponding devices described with reference to FIGS. 1-3, may communicate according to the FMCW signaling scheme 400.

In some examples, the network entity may avoid transmitting FCMW waveforms with a frequency jump (e.g., to decrease detector complexity). The network entity may be able to support such a frequency jump, but the UE may perform a single long receive sweep (e.g., may monitor for the FMCW across a single contiguous sweep across a frequency range 410 according to a slope value, as described in greater detail with reference to FIG. 2). In some examples, an FMCW design may include one or more chirps (e.g., without tails, or zero-tail transmissions). In some such designs, the FMCW may be transmitted as a single waveform (e.g., without a frequency jump) according to a slope value, where an FMCW chirp is transmitted from the beginning of a time interval (e.g., an OFDM symbol) to the end of the time interval in the time domain and from a first frequency resources to a second frequency resources (e.g., across a frequency range 410) in the frequency domain.

In some examples, an FMCW design 405 may include CP-OFDM compatible FMCW signaling. For example, according to the example FMCW design 405-a, the UE may transmit an FMCW 415 (e.g., including a frequency jump, such as a first portion of the FMCW 415-a and a second portion of the FMCW 415-b). Similarly, according to the FMCW design 405-b, the UE may transmit an FMCW 420 (e.g., including a frequency jump, such as a first portion of the FMCW 420-a and a second portion of the FMCW 420-b). In such examples (e.g., the FMCW design 405-a and the FMCW design 405-b), the detector (e.g., the receiving UE) may detect two separated FMCW beat frequencies, according to a special (e.g., defined) pattern in the time domain and the frequency domain. The UE may utilize a post processing procedure to address the frequency jump and interpret the FMCW burst (e.g., according to the detected special pattern in the time and frequency domain and the two separated FMCW beat frequencies).

In some examples, the FMCW bursts may be transmitted according to a zero tail FMCW design (e.g., the FMCW design 405-c, or the FMCW design 405-d, or another FMCW design including a zero tail FMCW). The zero tail FMCW for pre-SSB FMCW signaling may be OFDM compatible. In some examples, the FMCW duration may be less than an OFDM symbol duration (e.g., may be defined as 1/SCS). In such examples, a slope of the FMCW may be adjusted with a scalable pre-SSB FMCW duration. A faster chirp slope may shorten a receive sweep length L. For example, according to the example FMCW design 405-c, the FMCW 425 may have a duration less than the OFDM symbol duration (e.g., and may have a faster chirp slope shortening a receiver sweep length). A gap length may be equal to a cyclic prefix (CP) length (e.g., the gap 430-a and the gap 430-b may be equal to the CP length). Similarly, according to the example FMCW design 405-d, the FMCW 435 may have a duration less than the OFDM symbol duration (e.g., and may have a faster chirp slope shortening a receiver sweep length). A gap length may be equal to a cyclic prefix (CP) length or greater than a CP length (e.g., the gap 440-a may be equal to the CP length, and the gap 440-b may be greater than the CP length). In some such examples, the slope of the FMCW 435 may be steeper than the slope of the FMCW 425. Steeper slopes may result in earlier completion of reception and increased power saving.

In some examples, one or more parameters (e.g., bandwidth, such as the frequency range 410 or a set of raster points within a bandwidth, FMCW duration, slope, etc.) may be defined for transmission of the FMCW bursts. In some examples, such parameters may be defined in one or more standards documents, preconfigured at the UE, or configured (e.g., via control signaling) at the UE. In some examples, different sets of parameter values may define different FMCW designs (e.g., such as, but not limited to, the FMCW designs 405). In some examples, a set of parameters (e.g., an FMCW design 405, or another FMCW design) may be defined as a default FMCW design, which may be utilized (e.g., unless otherwise indicated, or according to one or more conditions or rules, among other examples). In some examples, different FMCW designs may be applied in different scenarios (e.g. according to one or more rules or conditions, according to a condition, according to one or more standards documents, etc.).

The UE may monitor for and receive the FMCW bursts, as described in greater detail with reference to FIGS. 5-6.

FIG. 5 shows an example of an FMCW detection procedure 500 that supports FMCW synchronization signal transmission and detection in accordance with one or more aspects of the present disclosure. The FMCW detection procedure 500 may implement, or be implemented by, aspects of the wireless communications system 100, the wireless communications system 200, the timeline 300, the timeline 301, and the FMCW signaling scheme 400. For example, one or more wireless devices (e.g., a network entity and a UE), which may be examples of corresponding devices described with reference to FIGS. 1-4, may communicate according to the FMCW detection procedure 500.

The network entity may transmit FMCW signaling (e.g., one or more FMCW bursts, such as FMCW-based PSS) over a set of raster points (e.g., raster points fᵢ). For example, the network entity may transmit an FMCW 505-a at the raster point f₀, and may transmit an FMCW 505-b at the raster point f₁. The FMCW duration for the FMCW 505-a and the FMCW 505-b may be T (e.g., such as a single symbol duration), and the bandwidth of each FMCW 505 may be indicated as B. For instance, the network entity may transmit the FMCW 505-a over time T and over the bandwidth B (e.g., from f₀ to f₀+B). Similarly, the network entity may transmit the FMCW 505-b (e.g., at a different time over time T) and over the bandwidth B (e.g., from f₁ to f₁+B).

The UE may have access to the set of raster points (e.g., which may be configured, preconfigured, or defined in one or more standards documents). However, the UE may not have access to information regarding which raster points the network entity transmits the FMCWs 505, or the start time of each FMCW 505 (e.g., for an initial search without timing knowledge acquired by the UE).

The UE may perform a receive sweep 515, and may use an FMCW to mix the received signal (e.g., as described with reference to FIG. 2). For example, the UE may generate a local FMCW (e.g., a copy of the FMCW that the network will use to transmit the FMCWs 505), and may mix the local FMCW with a received signal based on the receive sweep 515. The UE may start the receive sweep 515 at time 0 and a starting frequency (e.g., fₛ), with a slope of B/T. The duration of the receive sweep 515 may be L, where L>T. In some examples, the duration of L may be long enough to ensure that the receive sweep 515 spans multiple frequency raster points (e.g., f₀ and f₁, or any quantity of frequency raster points).

Because the UE does not know where the actual FMCW 505 for each frequency raster point is located, the UE may perform the receive sweep 515 according to the slope of B/T (e.g., based on the numerology of the FMCW 505, which may be defined by the standard or otherwise configured at the UE), monitoring for the FMCW 505 among a set of hypotheses FMCWs 510 (e.g., multiple hypothesis FMCWs 510-a for the raster point f₀ and multiple hypothesis FMCWs 510-b for the raster point f₁). The hypothesis FMCWs 510 may be located within a time period corresponding to a portion (e.g., L-T) of the receive sweep 515. That is, the portion L-T of the receive sweep 515 may define an effective range where the full FMCW sweep (e.g., the FMCW 505-a) can be covered (e.g., detected) by the receive sweep 515. For example, as described in greater detail with reference to FIG. 6, the UE may detect the FMCW 505-a by performing the receive sweep 515, because the receive sweep 515 overlaps with the region L-T. Based on the mixing of the received signal (e.g., based on the receive sweep 515) and the generated local FMCW, the UE may generate a beat frequency corresponding to the FMCW 505-a. The UE may determine a frequency offset based on the beat frequency, and a timing offset based on the frequency offset. Thus, the UE may determine a timing of the FMCW 505-a, and may perform coarse synchronization based on reception of one or more FMCW bursts. IN some examples, the UE may also receive one or more SSB bursts (e.g., based at least in part on successfully detecting the FMCW burst), and may performing fine synchronization based thereon.

FIG. 6 shows an example of an FMCW detection procedure 600 that supports FMCW synchronization signal transmission and detection in accordance with one or more aspects of the present disclosure. The FMCW detection procedure 600 may implement, or be implemented by, aspects of the wireless communications system 100, the wireless communications system 200, the timeline 300, the timeline 301, the FMCW signaling scheme 400, and the FMCW detection procedure 500. For example, one or more wireless devices (e.g., a network entity and a UE), which may be examples of corresponding devices described with reference to FIGS. 1-5, may communicate according to the FMCW detection procedure 600.

The UE may perform a receive sweep (e.g., as described with reference to FIG. 5) and may detect one or more FMCWs. Upon performing the mixing (e.g., mixing the received signal with the generated local FMCW), the UE may generate one or more beat signals 605. Based on the FMCW mixing, in the time and frequency domain, beat signal 605 may be represented as a horizontal line with length T. The beat signal 605 may start at time t∈[0, L−T]. The UE may generate a frequency offset (e.g., the frequency offset may be based on or equal to the beat frequency). The frequency offset may be defined as

$${f}_{i} - {f}_{S} - \frac{tB}{T} ,$$

where t represents a time offset. That is, the UE may utilize the frequency offset and the sync raster to determine the timing offset t. The timing offset t may indicate where to monitor for the next FMCW burst, SSB burst, or both.

In some examples, the UE may identify such a pattern (e.g., while achieving a high processing gain). For example, the UE may perform back-to-back fast Fourier transformations (FFTs) during a window 610. In some examples, the FFTs may have a duration T/2. The UE may identify the peak locations in the frequency domain based on the FFTs (e.g., where the peak locations correspond to detected FMCW transmissions). The duration of T/2 may be set such that one of the FFT windows 610 may capture the full pattern (e.g., of the FMCW).

In some examples, the UE may combine multiple (e.g., two) back-to-back long receive sweeps to enhance detection capability. For example, the pre-SSB may be partially covered by one long receive sweep, and the UE may perform a second long receive sweep to capture a remainder of the pre-SSB. In some examples, once the UE has detected two well separated beat frequencies (e.g., two beat frequencies based on a first portion of the FMCW received during a first receive sweep and a second portion of the FMCW received during a next back-to-back receive sweep, or two beat frequencies based on a CP-OFDM compatible FMCW, or based on detecting multiple FMCWs across one or multiple raster points), the UE may adjust its local FMCW generation timing. For example, the UE may shift its timing by T. In such examples, the UE may then be able to cover the entire pre-SSB FMCW in a next transmission cycle (e.g., because the FMCW is now received during a single receive sweep where a single beat frequency is detected, instead of across multiple receive sweeps).

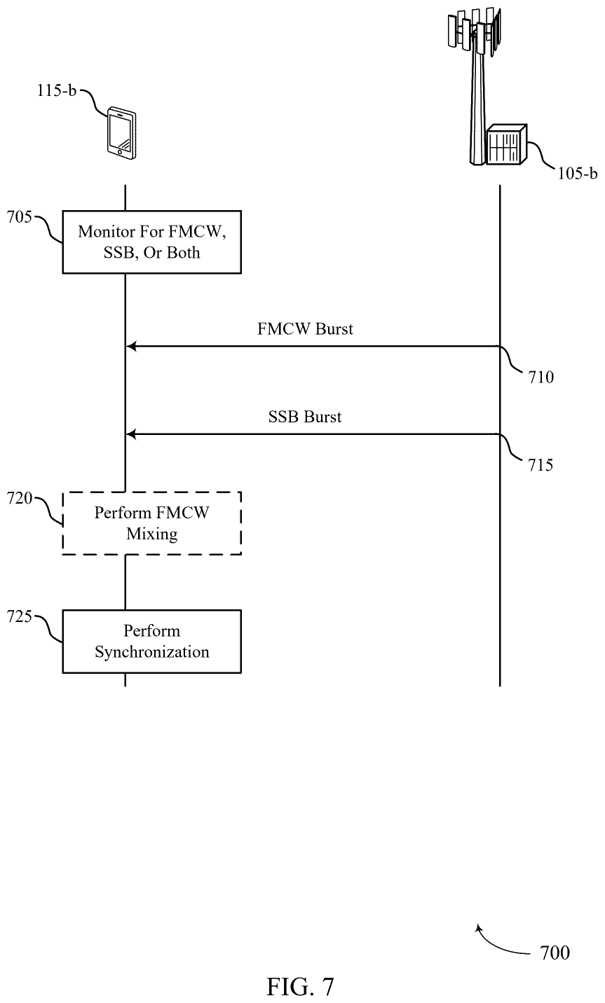

FIG. 7 shows an example of a process flow 700 that supports FMCW synchronization signal transmission and detection in accordance with one or more aspects of the present disclosure. The process flow may implement, or be implemented by, aspects of the wireless communications system 100, the wireless communications system 200, the timeline 300, the timeline 301, the FMCW signaling scheme 400, and the FMCW detection procedure 500, and the FMCW detection procedure 600. For example, the process flow 700 may include a network entity 105-b and a UE 115-b, which may be examples of corresponding devices described with reference to FIGS. 1-6.

At 705, the UE 115-b may monitor, according to a searching procedure, for at least one of a first FMCW burst, or a first SSB burst, or both. The monitoring may include sweeping multiple frequency resources during a first set of time resources according to a duration in time of each FMCW burst of the multiple FMCW bursts and a frequency range associated with each FMCW burst. The monitoring may include sweeping across the frequency resources a second time (e.g., two back-to-back long receive sweeps to enhance detection capability, such as in a case where pre-SSBs are partially covered by a single receive sweep). The UE 115-b may receive a first instance of the first FMCW burst during the first set of time resources, and a second instance of the first FMCW burst during the second set of time resources.

At 710, the network entity 105-b may output (e.g., transmit) one or more FMCW bursts via a first set of resources, and a first set of frequency resources, the first set of frequency resources corresponding to a first periodicity and the first set of frequency resources corresponding to at least a first raster point of a set of raster points in a frequency domain, the set of raster points indicating a plurality of noncontiguous frequency resources of the first set of frequency resources.

At 715, the network entity 105-b may output (e.g., transmit) a one or more synchronization SSB bursts via a second set of time resources according to a second periodicity and via the first set of frequency resources. The first periodicity may be equal to the second periodicity, greater than the first periodicity, or less than the first periodicity.

The network entity 105-b may generate FMCW chirps via the first set of time resources, the FMCW chirps corresponding to a slope value indicating a change in frequency over time. In such examples, outputting the FMCW bursts includes outputting the FMCW chirps. In some examples, one or more of the FMCW bursts including one or more of the plurality of FMCW chirps correspond to two separated FMCW beat frequencies and a unique pattern in time and frequency (e.g., the design 405-a or the design 405-b). In some examples, the FMCW duration in each time resource is less than a symbol duration, and an unoccupied portion of each time resources of the first set of time resources is equal to a cyclic prefix length (e.g., the design 405-c). In some examples, the FMCW duration in each time resource may be less than a symbol duration and an unoccupied portion of each time resources of the first set of time resources may be greater than a cyclic prefix length (e.g., the design 405-d).

The UE 115-b may receive at least one of the first FMCW burst at 710, or the SSB burst 715.

At 720, the UE 115-b may perform an FMCW mixing procedure based on the monitoring, to generate an FMCW signature pattern (e.g., a beat signal). The UE 115-b may perform one or more FFT procedures on the FMCW signature pattern to identify one or more peak locations in the frequency domain. The one or more peak locations may correspond to the first FMCW burst.

At 725, the UE 115-b may perform synchronization. For example, the UE 115-b may receive the FMCW burst at perform primary synchronization, and may receive the SSB burst at 715 (e.g., based on having received the FMCW burst at 710). The UE 115-b may perform a secondary synchronization based on receiving the first SSB burst.

In some examples, the UE may adjust a timing for monitoring for the FMCW bursts, and may sweep again having adjusted the duration in time (e.g., as described in greater detail with reference to FIG. 6). In some examples, the UE may detect a timing of the FMCW bursts, and may refrain from monitoring for a second FMCW burst, an SSB burst, or both, for a time duration based on the first periodicity, the second periodicity, a time offset between each FMCW burst and a next SSB burst, or a combination thereof.

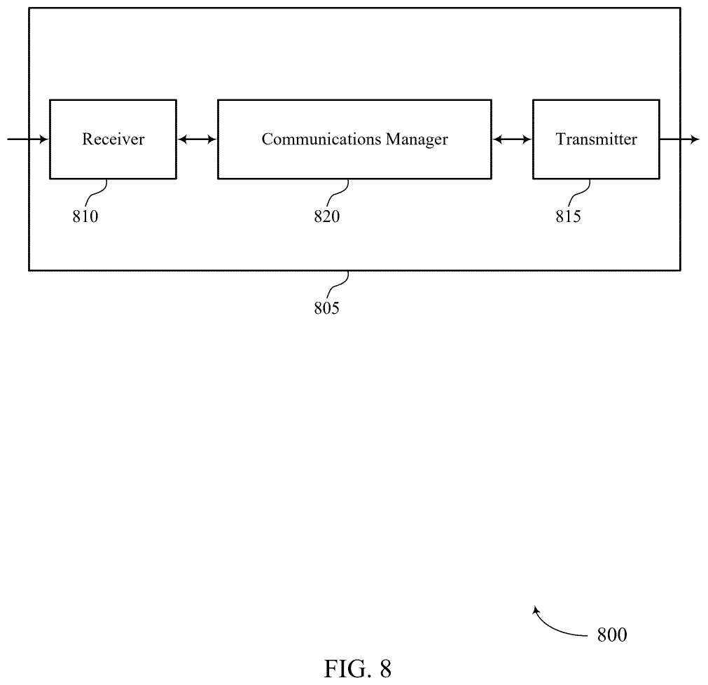

FIG. 8 shows a block diagram 800 of a device 805 that supports FMCW synchronization signal transmission and detection in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to FMCW synchronization signal transmission and detection). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to FMCW synchronization signal transmission and detection). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of FMCW synchronization signal transmission and detection as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for monitoring, according to a searching procedure, for at least one of a first FMCW of a set of multiple FMCWs, or a first SSB burst of a set of multiple SSB bursts, the monitoring including sweeping across a set of multiple frequency resources during a first set of time resources according to a duration in time of each FMCW of the set of multiple FMCWs and a frequency range associated with each FMCW of the set of multiple FMCWs. The communications manager 820 is capable of, configured to, or operable to support a means for receiving at least one of the first FMCW or the first SSB burst based on the monitoring.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for cell detection and synchronization, resulting in decreased complexity, more efficient use of computational resources, more efficient use of available system resources, increased power savings, and improved coordination between devices.

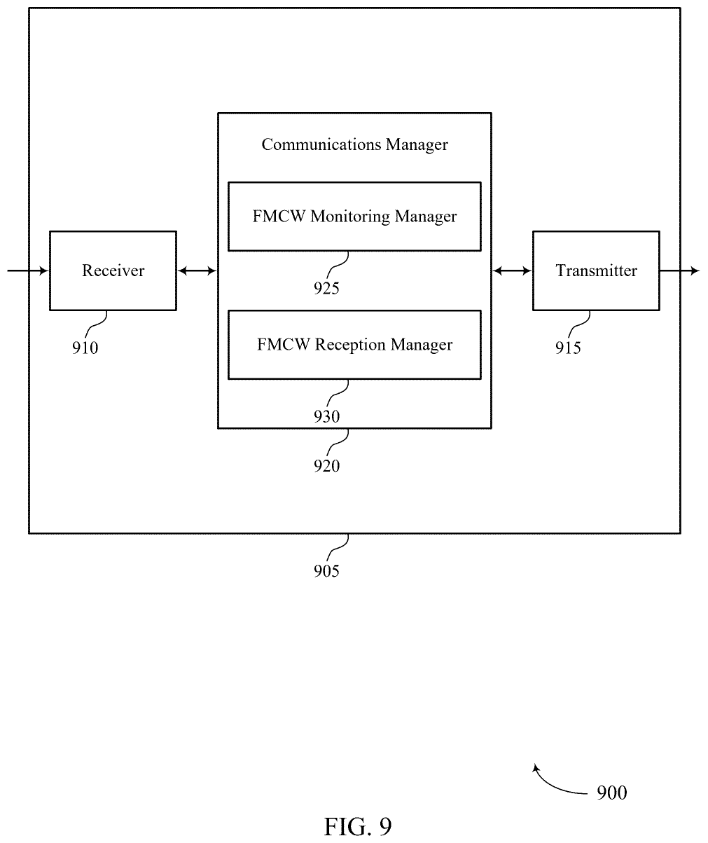

FIG. 9 shows a block diagram 900 of a device 905 that supports FMCW synchronization signal transmission and detection in accordance with one or more aspects of the present disclosure. The device 905 may be an example of aspects of a device 805 or a UE 115 as described herein. The device 905 may include a receiver 910, a transmitter 915, and a communications manager 920. The device 905, or one of more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to FMCW synchronization signal transmission and detection). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to FMCW synchronization signal transmission and detection). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of FMCW synchronization signal transmission and detection as described herein. For example, the communications manager 920 may include an FMCW monitoring manager 925 an FMCW reception manager 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The FMCW monitoring manager 925 is capable of, configured to, or operable to support a means for monitoring, according to a searching procedure, for at least one of a first FMCW of a set of multiple FMCWs, or a first SSB burst of a set of multiple SSB bursts, the monitoring including sweeping across a set of multiple frequency resources during a first set of time resources according to a duration in time of each FMCW of the set of multiple FMCWs and a frequency range associated with each FMCW of the set of multiple FMCWs. The FMCW reception manager 930 is capable of, configured to, or operable to support a means for receiving at least one of the first FMCW or the first SSB burst based on the monitoring.

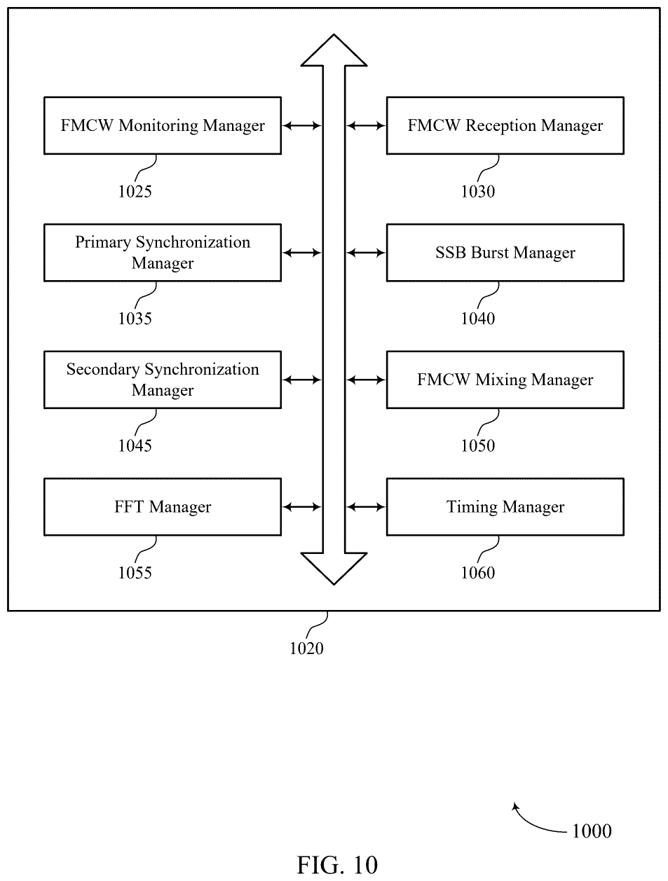

FIG. 10 shows a block diagram 1000 of a communications manager 1020 that supports FMCW synchronization signal transmission and detection in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of FMCW synchronization signal transmission and detection as described herein. For example, the communications manager 1020 may include an FMCW monitoring manager 1025, an FMCW reception manager 1030, a primary synchronization manager 1035, an SSB burst manager 1040, a secondary synchronization manager 1045, an FMCW mixing manager 1050, an FFT manager 1055, a timing manager 1060, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The FMCW monitoring manager 1025 is capable of, configured to, or operable to support a means for monitoring, according to a searching procedure, for at least one of a first FMCW of a set of multiple FMCWs, or a first SSB burst of a set of multiple SSB bursts, the monitoring including sweeping across a set of multiple frequency resources during a first set of time resources according to a duration in time of each FMCW of the set of multiple FMCW and a frequency range associated with each FMCW of the set of multiple FMCW. The FMCW reception manager 1030 is capable of, configured to, or operable to support a means for receiving at least one of the first FMCW or the first SSB burst based on the monitoring.

In some examples, the primary synchronization manager 1035 is capable of, configured to, or operable to support a means for performing a primary synchronization based on receiving the first FMCW. In some examples, the SSB burst manager 1040 is capable of, configured to, or operable to support a means for receiving the first SSB burst based on the primary synchronization. In some examples, the secondary synchronization manager 1045 is capable of, configured to, or operable to support a means for performing a secondary synchronization based on receiving the first SSB burst.

In some examples, the FMCW mixing manager 1050 is capable of, configured to, or operable to support a means for performing an FMCW mixing procedure based on the monitoring to generate a beat signal. In some examples, the FFT manager 1055 is capable of, configured to, or operable to support a means for performing one or more Fast Fourier Transforms on the beat signal to identify one or more peak locations in a frequency domain, the one or more peak locations corresponding to the first FMCW.

In some examples, to support monitoring, the FMCW monitoring manager 1025 is capable of, configured to, or operable to support a means for sweeping across the set of multiple frequency resources during a second set of time resources according to a slope value that is based on the duration in time of each FMCW of the set of multiple FMCWs and the frequency range associated with each FMCW of the set of multiple FMCWs.

In some examples, to support receiving the first FMCW, the FMCW reception manager 1030 is capable of, configured to, or operable to support a means for receiving a first instance of the first FMCW during the first set of time resources. In some examples, to support receiving the first FMCW, the FMCW reception manager 1030 is capable of, configured to, or operable to support a means for receiving a second instance of the first FMCW during the second set of time resources.

In some examples, the FMCW reception manager 1030 is capable of, configured to, or operable to support a means for receiving a first portion of the first FMCW during the first set of time resources. In some examples, the timing manager 1060 is capable of, configured to, or operable to support a means for adjusting a timing for monitoring for the set of multiple FMCWs. In some examples, the FMCW reception manager 1030 is capable of, configured to, or operable to support a means for sweeping across the set of multiple frequency resources during a second set of time resources according to a slope value that is based on the duration in time of each FMCW of the set of multiple FMCWs and a frequency range associated with each FMCW of the set of multiple FMCWs, and based on the adjusted timing, where receiving the first FMCW is based on sweeping the frequency resources during the second set of time resources.

In some examples, the set of multiple FMCWs are transmitted at a first periodicity, and the set of multiple SSB bursts are transmitted at a second periodicity.

In some examples, the timing manager 1060 is capable of, configured to, or operable to support a means for detecting, based on receiving the first FMCW, a timing of the set of multiple FMCWs. In some examples, the FMCW monitoring manager 1025 is capable of, configured to, or operable to support a means for refraining from monitoring for a second FMCW, the first SSB burst, or both, for a time duration that is based on the first periodicity, the second periodicity, a time offset between each FMCW of the set of multiple FMCWs and a next SSB burst of the set of multiple SSB bursts, or any combination thereof.

In some examples, the FMCW reception manager 1030 is capable of, configured to, or operable to support a means for detecting, based on the monitoring, multiple FMCW beat frequencies. In some examples, the FMCW reception manager 1030 is capable of, configured to, or operable to support a means for identifying a unique pattern in time and frequency based on the detecting, where receiving the first FMCW is based on the identifying.

In some examples, the FMCW reception manager 1030 is capable of, configured to, or operable to support a means for detecting, based on the monitoring, a zero tail FMCW waveform having a duration that is less than an orthogonal frequency division multiplexing symbol, where receiving the first FMCW is based on the detecting.

In some examples, the searching procedure includes a cell search procedure, a beam management procedure, a tracking loop procedure, or any combination thereof.

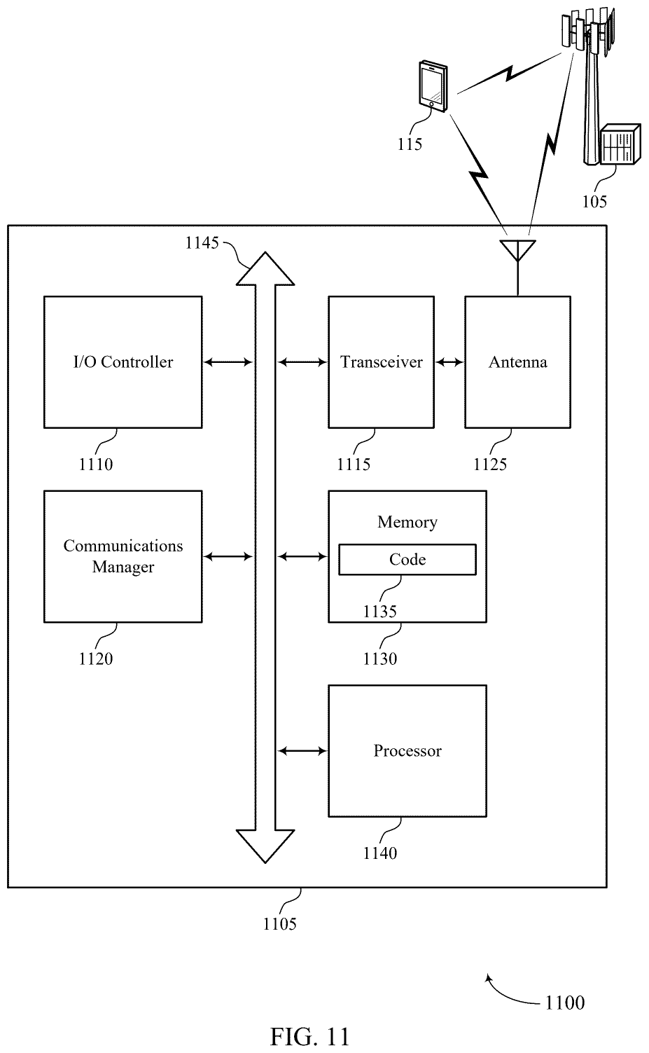

FIG. 11 shows a diagram of a system 1100 including a device 1105 that supports FMCW synchronization signal transmission and detection in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting FMCW synchronization signal transmission and detection). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for monitoring, according to a searching procedure, for at least one of a first FMCW of a set of multiple FMCWs, or a first SSB burst of a set of multiple SSB bursts, the monitoring including sweeping across a set of multiple frequency resources during a first set of time resources according to a duration in time of each FMCW of the set of multiple FMCWs and a frequency range associated with each FMCW of the set of multiple FMCWs. The communications manager 1120 is capable of, configured to, or operable to support a means for receiving at least one of the first FMCW or the first SSB burst based on the monitoring.

By including or configuring the communications manager 1120 in accordance with examples as described herein, the device 1105 may support techniques for cell detection and synchronization, resulting in decreased complexity, more efficient use of computational resources, more efficient use of available system resources, reduced processing, increased power savings, longer battery life, improved coordination between devices, and improved user experience.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of FMCW synchronization signal transmission and detection as described herein, or the at least one processor 1140 and the at least one memory 1130 may be otherwise configured to, individually or collectively, perform or support such operations.

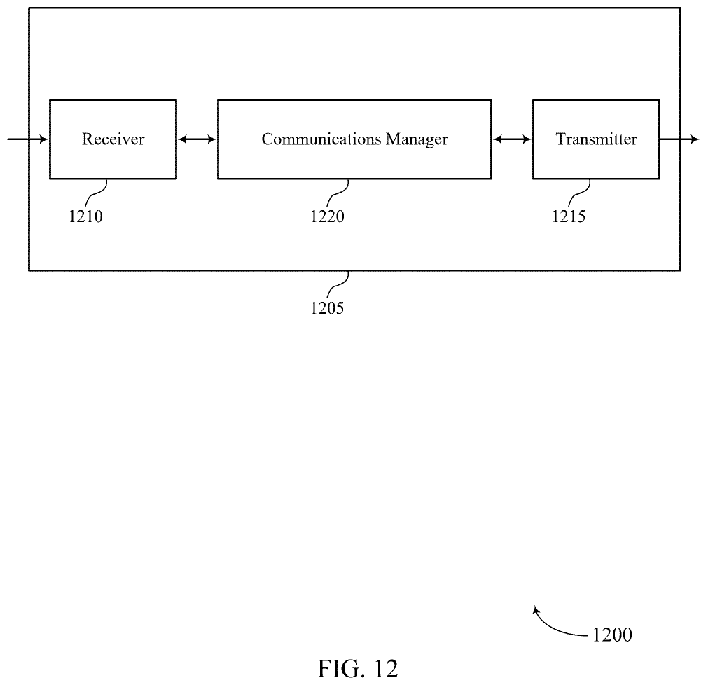

FIG. 12 shows a block diagram 1200 of a device 1205 that supports FMCW synchronization signal transmission and detection in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of FMCW synchronization signal transmission and detection as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for outputting a set of multiple FMCW bursts via a first set of time resources and a first set of frequency resources, the first set of frequency resources corresponding to a first periodicity and the first set of frequency resources corresponding to at least a first raster point of a set of raster points in a frequency domain, the set of raster points indicating a set of multiple noncontiguous frequency resources of the first set of frequency resources. The communications manager 1220 is capable of, configured to, or operable to support a means for outputting a set of multiple SSB bursts via a second set of time resources according to a second periodicity and via the first set of frequency resources.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for cell detection and synchronization, resulting in decreased complexity, more efficient use of computational resources, more efficient use of available system resources, increased power savings, and improved coordination between devices.

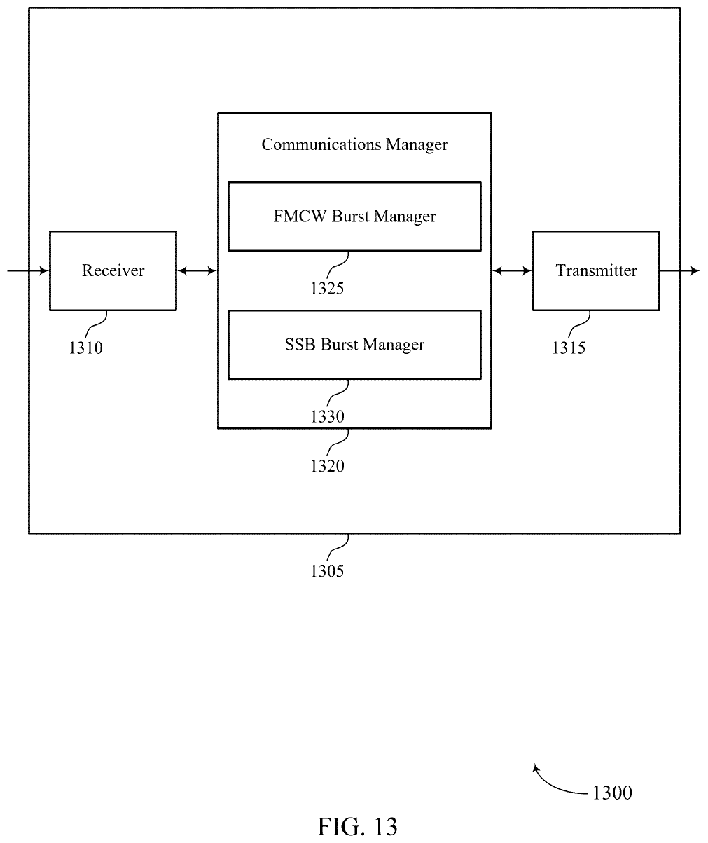

FIG. 13 shows a block diagram 1300 of a device 1305 that supports FMCW synchronization signal transmission and detection in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one of more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of FMCW synchronization signal transmission and detection as described herein. For example, the communications manager 1320 may include an FMCW burst manager 1325 an SSB burst manager 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The FMCW burst manager 1325 is capable of, configured to, or operable to support a means for outputting a set of multiple FMCW bursts via a first set of time resources and a first set of frequency resources, the first set of frequency resources corresponding to a first periodicity and the first set of frequency resources corresponding to at least a first raster point of a set of raster points in a frequency domain, the set of raster points indicating a set of multiple noncontiguous frequency resources of the first set of frequency resources. The SSB burst manager 1330 is capable of, configured to, or operable to support a means for outputting a set of multiple SSB bursts via a second set of time resources according to a second periodicity and via the first set of frequency resources.

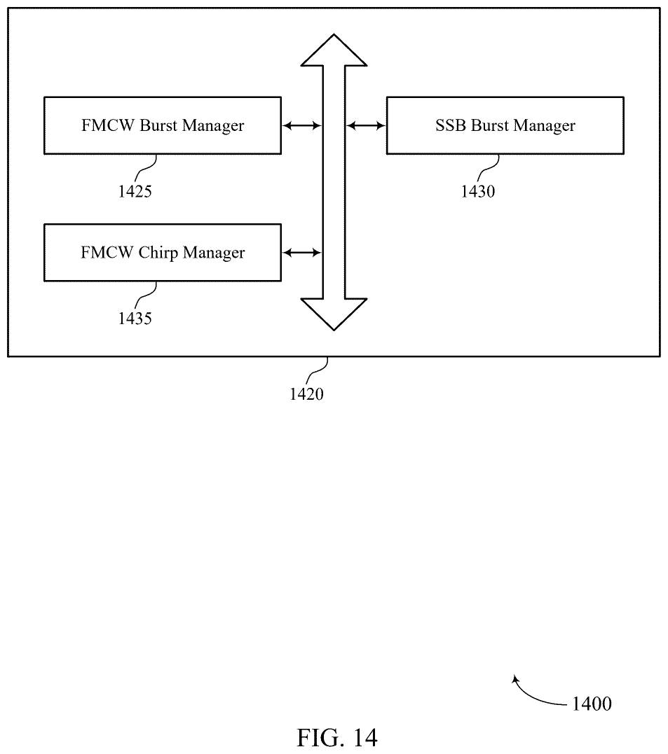

FIG. 14 shows a block diagram 1400 of a communications manager 1420 that supports FMCW synchronization signal transmission and detection in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of FMCW synchronization signal transmission and detection as described herein. For example, the communications manager 1420 may include an FMCW burst manager 1425, an SSB burst manager 1430, an FMCW chirp manager 1435, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications in accordance with examples as disclosed herein. The FMCW burst manager 1425 is capable of, configured to, or operable to support a means for outputting a set of multiple FMCW bursts via a first set of time resources and a first set of frequency resources, the first set of frequency resources corresponding to a first periodicity and the first set of frequency resources corresponding to at least a first raster point of a set of raster points in a frequency domain, the set of raster points indicating a set of multiple noncontiguous frequency resources of the first set of frequency resources. The SSB burst manager 1430 is capable of, configured to, or operable to support a means for outputting a set of multiple SSB bursts via a second set of time resources according to a second periodicity and via the first set of frequency resources.

In some examples, the FMCW chirp manager 1435 is capable of, configured to, or operable to support a means for generating a set of multiple FMCW chirps via the first set of time resources, the set of multiple FMCW chirps corresponding to a slope value indicating a change in frequency over time, where outputting the set of multiple FMCW bursts is based on outputting the set of multiple FMCW chirps.

In some examples, each of the set of multiple FMCW bursts including one or more of the set of multiple FMCW chirps correspond to two separated FMCW beat frequencies and a unique pattern in time and frequency.

In some examples, an FMCW duration in each time resource of the first set of time resources is less than a symbol duration, and an unoccupied portion of each time resources of the first set of time resources is equal to a cyclic prefix length.

In some examples, an FMCW duration in each time resource of the first set of time resources is less than a symbol duration, and an unoccupied portion of each time resources of the first set of time resources is greater than a cyclic prefix length.

In some examples, the first periodicity is equal to the second periodicity.

In some examples, the first periodicity is greater than the second periodicity.

In some examples, the first periodicity is smaller than the second periodicity.

In some examples, an offset value indicates an offset between each respective FMCW burst of the set of multiple FMCW bursts and a next SSB burst of the set of multiple SSB bursts.

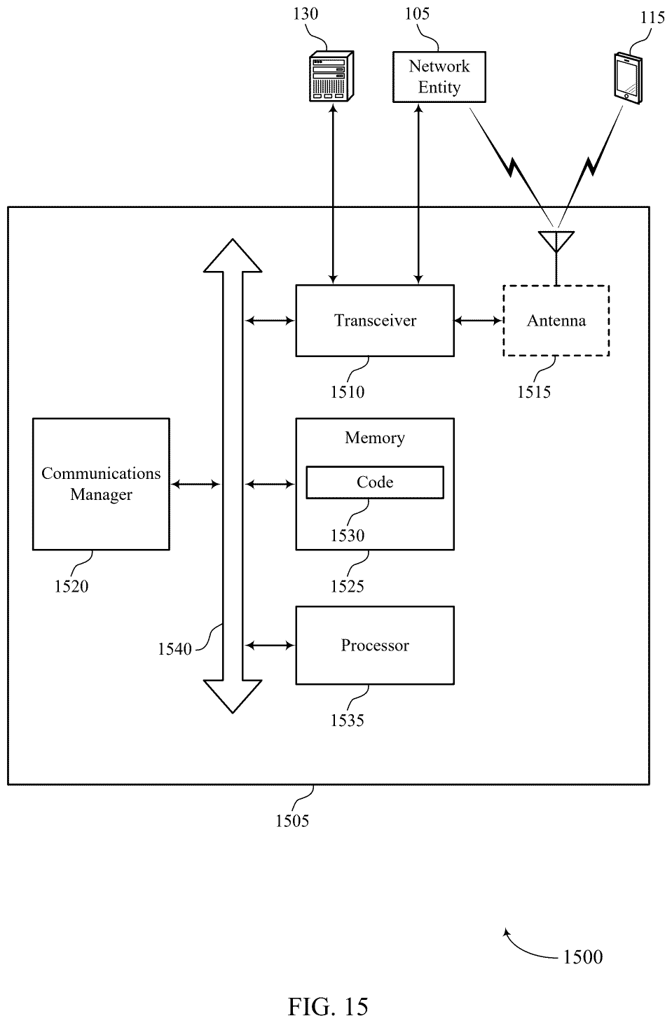

FIG. 15 shows a diagram of a system 1500 including a device 1505 that supports FMCW synchronization signal transmission and detection in accordance with one or more aspects of the present disclosure. The device 1505 may be an example of or include components of a device 1205, a device 1305, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting FMCW synchronization signal transmission and detection). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for outputting a set of multiple FMCW bursts via a first set of time resources and a first set of frequency resources, the first set of frequency resources corresponding to a first periodicity and the first set of frequency resources corresponding to at least a first raster point of a set of raster points in a frequency domain, the set of raster points indicating a set of multiple noncontiguous frequency resources of the first set of frequency resources. The communications manager 1520 is capable of, configured to, or operable to support a means for outputting a set of multiple SSB bursts via a second set of time resources according to a second periodicity and via the first set of frequency resources.

By including or configuring the communications manager 1520 in accordance with examples as described herein, the device 1505 may support techniques for cell detection and synchronization, resulting in decreased complexity, more efficient use of computational resources, more efficient use of available system resources, reduced processing, increased power savings, longer battery life, improved coordination between devices, and improved user experience.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of FMCW synchronization signal transmission and detection as described herein, or the at least one processor 1535 and the at least one memory 1525 may be otherwise configured to, individually or collectively, perform or support such operations.

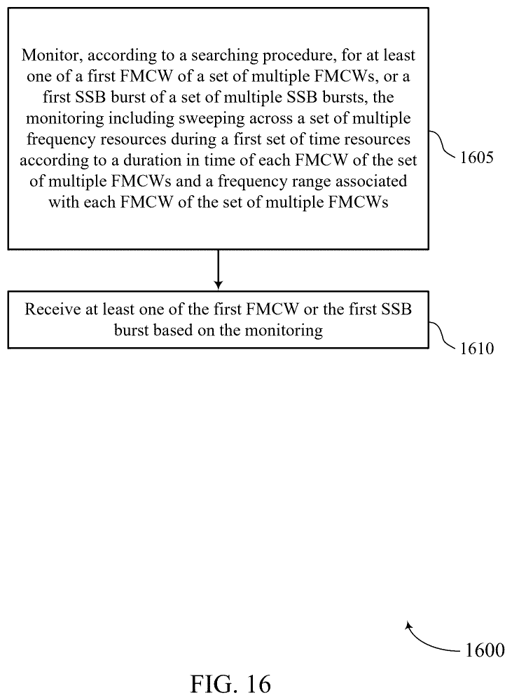

FIG. 16 shows a flowchart illustrating a method 1600 that supports FMCW synchronization signal transmission and detection in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include monitoring, according to a searching procedure, for at least one of a first FMCW of a set of multiple FMCWs, or a first SSB burst of a set of multiple SSB bursts, the monitoring including sweeping across a set of multiple frequency resources during a first set of time resources according to a duration in time of each FMCW of the set of multiple FMCWs and a frequency range associated with each FMCW of the set of multiple FMCWs. The operations of 1605 may be performed in accordance with examples as disclosed herein. In some examples, aspects of the operations of 1605 may be performed by an FMCW monitoring manager 1025 as described with reference to FIG. 10.

At 1610, the method may include receiving at least one of the first FMCW or the first SSB burst based on the monitoring. The operations of 1610 may be performed in accordance with examples as disclosed herein. In some examples, aspects of the operations of 1610 may be performed by an FMCW reception manager 1030 as described with reference to FIG. 10.

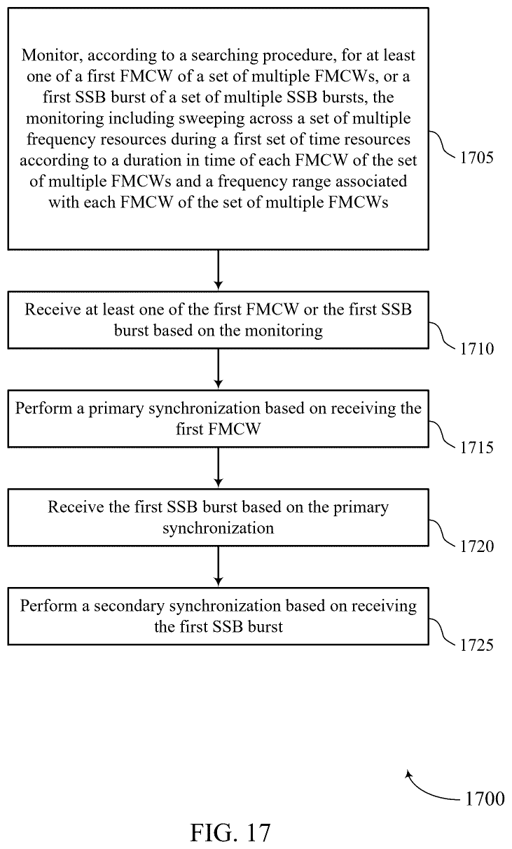

FIG. 17 shows a flowchart illustrating a method 1700 that supports FMCW synchronization signal transmission and detection in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include monitoring, according to a searching procedure, for at least one of a first FMCW of a set of multiple FMCWs, or a first SSB burst of a set of multiple SSB bursts, the monitoring including sweeping across a set of multiple frequency resources during a first set of time resources according to a duration in time of each FMCW of the set of multiple FMCWs and a frequency range associated with each FMCW of the set of multiple FMCWs. The operations of 1705 may be performed in accordance with examples as disclosed herein. In some examples, aspects of the operations of 1705 may be performed by an FMCW monitoring manager 1025 as described with reference to FIG. 10.

At 1710, the method may include receiving at least one of the first FMCW or the first SSB burst based on the monitoring. The operations of 1710 may be performed in accordance with examples as disclosed herein. In some examples, aspects of the operations of 1710 may be performed by an FMCW reception manager 1030 as described with reference to FIG. 10.

At 1715, the method may include performing a primary synchronization based on receiving the first FMCW. The operations of 1715 may be performed in accordance with examples as disclosed herein. In some examples, aspects of the operations of 1715 may be performed by a primary synchronization manager 1035 as described with reference to FIG. 10.

At 1720, the method may include receiving the first SSB burst based on the primary synchronization. The operations of 1720 may be performed in accordance with examples as disclosed herein. In some examples, aspects of the operations of 1720 may be performed by an SSB burst manager 1040 as described with reference to FIG. 10.

At 1725, the method may include performing a secondary synchronization based on receiving the first SSB burst. The operations of 1725 may be performed in accordance with examples as disclosed herein. In some examples, aspects of the operations of 1725 may be performed by a secondary synchronization manager 1045 as described with reference to FIG. 10.

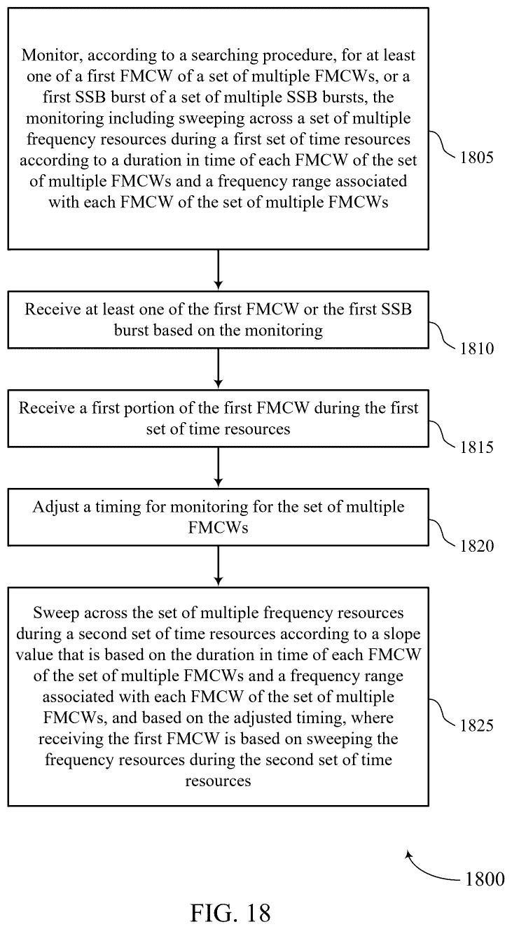

FIG. 18 shows a flowchart illustrating a method 1800 that supports FMCW synchronization signal transmission and detection in accordance with one or more aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1805, the method may include monitoring, according to a searching procedure, for at least one of a first FMCW of a set of multiple FMCWs, or a first SSB burst of a set of multiple SSB bursts, the monitoring including sweeping across a set of multiple frequency resources during a first set of time resources according to a duration in time of each FMCW of the set of multiple FMCWs and a frequency range associated with each FMCW of the set of multiple FMCWs. The operations of 1805 may be performed in accordance with examples as disclosed herein. In some examples, aspects of the operations of 1805 may be performed by an FMCW monitoring manager 1025 as described with reference to FIG. 10.

At 1810, the method may include receiving at least one of the first FMCW or the first SSB burst based on the monitoring. The operations of 1810 may be performed in accordance with examples as disclosed herein. In some examples, aspects of the operations of 1810 may be performed by an FMCW reception manager 1030 as described with reference to FIG. 10.

At 1815, the method may include receiving a first portion of the first FMCW during the first set of time resources. The operations of 1815 may be performed in accordance with examples as disclosed herein. In some examples, aspects of the operations of 1815 may be performed by an FMCW reception manager 1030 as described with reference to FIG. 10.

At 1820, the method may include adjusting a timing for monitoring for the set of multiple FMCWs. The operations of 1820 may be performed in accordance with examples as disclosed herein. In some examples, aspects of the operations of 1820 may be performed by a timing manager 1060 as described with reference to FIG. 10.

At 1825, the method may include sweeping across the set of multiple frequency resources during a second set of time resources according to a slope value that is based on the duration in time of each FMCW of the set of multiple FMCWs and a frequency range associated with each FMCW of the set of multiple FMCWs, and based on the adjusted timing, where receiving the first FMCW is based on sweeping the frequency resources during the second set of time resources. The operations of 1825 may be performed in accordance with examples as disclosed herein. In some examples, aspects of the operations of 1825 may be performed by an FMCW reception manager 1030 as described with reference to FIG. 10.

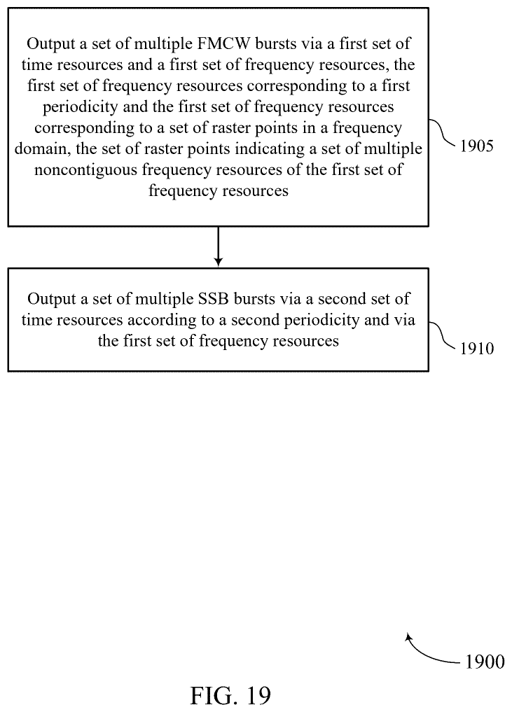

FIG. 19 shows a flowchart illustrating a method 1900 that supports FMCW synchronization signal transmission and detection in accordance with one or more aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1905, the method may include outputting a set of multiple FMCW bursts via a first set of time resources and a first set of frequency resources, the first set of frequency resources corresponding to a first periodicity and the first set of frequency resources corresponding to at least a first raster point of a set of raster points in a frequency domain, the set of raster points indicating a set of multiple noncontiguous frequency resources of the first set of frequency resources. The operations of 1905 may be performed in accordance with examples as disclosed herein. In some examples, aspects of the operations of 1905 may be performed by an FMCW burst manager 1425 as described with reference to FIG. 14.

At 1910, the method may include outputting a set of multiple SSB bursts via a second set of time resources according to a second periodicity and via the first set of frequency resources. The operations of 1910 may be performed in accordance with examples as disclosed herein. In some examples, aspects of the operations of 1910 may be performed by an SSB burst manager 1430 as described with reference to FIG. 14.

The following provides an overview of aspects of the present disclosure:
Aspect 1: A method for wireless communications at a UE, comprising: monitoring, according to a searching procedure, for at least one of a first frequency modulated continuous wave (FMCW) of a plurality of FMCWs, or a first synchronization signal block (SSB) burst of a plurality of SSB bursts, the monitoring comprising sweeping across a plurality of frequency resources during a first set of time resources according to a duration in time of each FMCW of the plurality of FMCWs and a frequency range associated with each FMCW of the plurality of FMCWs; and receiving at least one of the first FMCW or the first SSB burst based at least in part on the monitoring.
Aspect 2: The method of aspect 1, further comprising: performing a primary synchronization based at least in part on receiving the first FMCW; receiving the first SSB burst based at least in part on the primary synchronization; and performing a secondary synchronization based at least in part on reception of the first SSB burst.
Aspect 3: The method of any of aspects 1 through 2, further comprising: performing an FMCW mixing procedure based at least in part on the monitoring to generate a beat signal; and performing one or more Fast Fourier Transforms on the beat signal to identify one or more peak locations in a frequency domain, the one or more peak locations corresponding to the first FMCW.
Aspect 4: The method of any of aspects 1 through 3, further comprising: sweeping across the plurality of frequency resources during a second set of time resources according to a slope value that is based at least in part on the duration in time of each FMCW of the plurality of FMCWs and the frequency range associated with each FMCW of the plurality of FMCWs.
Aspect 5: The method of aspect 4, wherein receiving the first FMCW comprises: receiving a first instance of the first FMCW during the first set of time resources; and receiving a second instance of the first FMCW during the second set of time resources.
Aspect 6: The method of any of aspects 1 through 5, further comprising: receiving a first portion of the first FMCW during the first set of time resources; adjusting a timing for monitoring for the plurality of FMCWs; and sweeping across the plurality of frequency resources during a second set of time resources according to a slope value that is based at least in part on the duration in time of each FMCW of the plurality of FMCWs and a frequency range associated with each FMCW of the plurality of FMCWs, and based at least in part on the adjusted timing, wherein reception of the first FMCW is based at least in part on sweeping the frequency resources during the second set of time resources.
Aspect 7: The method of any of aspects 1 through 6, wherein the plurality of FMCWs are transmitted at a first periodicity, and the plurality of SSB bursts are transmitted at a second periodicity.
Aspect 8: The method of aspect 7, further comprising: detecting, based at least in part on reception of the first FMCW, a timing of the plurality of FMCWs; and refraining from monitoring for a second FMCW, the first SSB burst, or both, for a time duration that is based at least in part on the first periodicity, the second periodicity, a time offset between each FMCW of the plurality of FMCWs and a next SSB burst of the plurality of SSB bursts, or any combination thereof.
Aspect 9: The method of any of aspects 1 through 8, further comprising: detecting, based at least in part on the monitoring, multiple FMCW beat frequencies; and identifying a unique pattern in time and frequency based at least in part on the detection, wherein reception of the first FMCW is based at least in part on the identifying.
Aspect 10: The method of any of aspects 1 through 9, further comprising: detecting, based at least in part on the monitoring, a zero tail FMCW waveform having a duration that is less than an orthogonal frequency division multiplexing symbol, wherein reception of the first FMCW is based at least in part on the detection.
Aspect 11: The method of any of aspects 1 through 10, wherein the searching procedure comprises a cell search procedure, a beam management procedure, a tracking loop procedure, or any combination thereof.
Aspect 12: A method for wireless communication at a network entity, comprising: output a plurality of frequency modulated continuous wave (FMCW) bursts via a first set of time resources and a first set of frequency resources, the first set of frequency resources corresponding to a first periodicity and the first set of frequency resources corresponding to at least a first raster point of a set of raster points in a frequency domain, the set of raster points indicating a plurality of noncontiguous frequency resources of the first set of frequency resources; and output a plurality of synchronization signal block (SSB) bursts via a second set of time resources according to a second periodicity and via the first set of frequency resources.
Aspect 13: The method of aspect 12, further comprising: generating a plurality of FMCW chirps via the first set of time resources, the plurality of FMCW chirps corresponding to a slope value indicating a change in frequency over time, wherein outputting the plurality of FMCW bursts is based at least in part on outputting the plurality of FMCW chirps.
Aspect 14: The method of aspect 13, wherein each of the plurality of FMCW bursts comprising one or more of the plurality of FMCW chirps correspond to two separated FMCW beat frequencies and a unique pattern in time and frequency.
Aspect 15: The method of any of aspects 13 through 14, wherein an FMCW duration in each time resource of the first set of time resources is less than a symbol duration, and an unoccupied portion of each time resources of the first set of time resources is equal to a cyclic prefix length.
Aspect 16: The method of any of aspects 13 through 15, wherein an FMCW duration in each time resource of the first set of time resources is less than a symbol duration, and an unoccupied portion of each time resources of the first set of time resources is greater than a cyclic prefix length.
Aspect 17: The method of any of aspects 12 through 16, wherein the first periodicity is equal to the second periodicity.
Aspect 18: The method of any of aspects 12 through 17, wherein the first periodicity is greater than the second periodicity.
Aspect 19: The method of any of aspects 12 through 18, wherein the first periodicity is smaller than the second periodicity.
Aspect 20: The method of any of aspects 12 through 19, wherein an offset value indicates an offset between each respective FMCW burst of the plurality of FMCW bursts and a next SSB burst of the plurality of SSB bursts.
Aspect 21: A UE for wireless communications, comprising one or more memories storing processor-executable code, and one or more processors coupled with the one or more memories and individually or collectively operable to execute the code to cause the UE to perform a method of any of aspects 1 through 11.
Aspect 22: A UE for wireless communications, comprising at least one means for performing a method of any of aspects 1 through 11.
Aspect 23: A non-transitory computer-readable medium storing code for wireless communications, the code comprising instructions executable by one or more processors to perform a method of any of aspects 1 through 11.
Aspect 24: A network entity for wireless communication, comprising one or more memories storing processor-executable code, and one or more processors coupled with the one or more memories and individually or collectively operable to execute the code to cause the network entity to perform a method of any of aspects 12 through 20.
Aspect 25: A network entity for wireless communication, comprising at least one means for performing a method of any of aspects 12 through 20.
Aspect 26: A non-transitory computer-readable medium storing code for wireless communication, the code comprising instructions executable by one or more processors to perform a method of any of aspects 12 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE), comprising:
one or more memories storing processor-executable code; and
one or more processors coupled with the one or more memories and individually or collectively operable to execute the code to cause the UE to:
monitor, according to a searching procedure, for at least one of a first frequency modulated continuous wave (FMCW) of a plurality of FMCWs, or a first synchronization signal block (SSB) burst of a plurality of SSB bursts, the monitoring comprising sweeping across a plurality of frequency resources during a first set of time resources according to a duration in time of each FMCW of the plurality of FMCWs and a frequency range associated with each FMCW of the plurality of FMCWs; and
receive at least one of the first FMCW or the first SSB burst based at least in part on the monitoring.

2. The UE of claim 1, wherein the one or more processors are individually or collectively further operable to execute the code to cause the UE to:
perform a primary synchronization based at least in part on receiving the first FMCW;
receive the first SSB burst based at least in part on the primary synchronization; and
perform a secondary synchronization based at least in part on reception of the first SSB burst.

3. The UE of claim 1, wherein the one or more processors are individually or collectively further operable to execute the code to cause the UE to:
perform an FMCW mixing procedure based at least in part on the monitoring to generate a beat signal; and
perform one or more Fast Fourier Transforms on the beat signal to identify one or more peak locations in a frequency domain, the one or more peak locations corresponding to the first FMCW.

4. The UE of claim 1, wherein, to monitor, the one or more processors are individually or collectively operable to execute the code to cause the UE to:
sweep across the plurality of frequency resources during a second set of time resources according to a slope value that is based at least in part on the duration in time of each FMCW of the plurality of FMCWs and the frequency range associated with each FMCW of the plurality of FMCWs.

5. The UE of claim 4, wherein, to receive the first FMCW, the one or more processors are individually or collectively operable to execute the code to cause the UE to:
receive a first instance of the first FMCW during the first set of time resources; and
receive a second instance of the first FMCW during the second set of time resources.

6. The UE of claim 1, wherein the one or more processors are individually or collectively further operable to execute the code to cause the UE to:
receive a first portion of the first FMCW during the first set of time resources;
adjust a timing for monitoring for the plurality of FMCWs; and
sweep across the plurality of frequency resources during a second set of time resources according to a slope value that is based at least in part on the duration in time of each FMCW of the plurality of FMCWs and a frequency range associated with each FMCW of the plurality of FMCWs, and based at least in part on the adjusted timing, wherein reception of the first FMCW is based at least in part on sweeping the frequency resources during the second set of time resources.

7. The UE of claim 1, wherein the plurality of FMCWs are transmitted at a first periodicity, and the plurality of SSB bursts are transmitted at a second periodicity.

8. The UE of claim 7, wherein the one or more processors are individually or collectively further operable to execute the code to cause the UE to:
detect, based at least in part on reception of the first FMCW, a timing of the plurality of FMCWs; and
refrain from monitoring for a second FMCW, the first SSB burst, or both, for a time duration that is based at least in part on the first periodicity, the second periodicity, a time offset between each FMCW of the plurality of FMCWs and a next SSB burst of the plurality of SSB bursts, or any combination thereof.

9. The UE of claim 1, wherein the one or more processors are individually or collectively further operable to execute the code to cause the UE to:
detect, based at least in part on the monitoring, multiple FMCW beat frequencies; and
identify a unique pattern in time and frequency based at least in part on the detection, wherein reception of the first FMCW is based at least in part on the identifying.

10. The UE of claim 1, wherein the one or more processors are individually or collectively further operable to execute the code to cause the UE to:
detect, based at least in part on the monitoring, a zero tail FMCW waveform having a duration that is less than an orthogonal frequency division multiplexing symbol, wherein reception of the first FMCW is based at least in part on the detection.

11. The UE of claim 1, wherein the searching procedure comprises a cell search procedure, a beam management procedure, a tracking loop procedure, or any combination thereof.

12-20. (canceled)

21. A method for wireless communications at a user equipment (UE), comprising:
monitoring, according to a searching procedure, for at least one of a first frequency modulated continuous wave (FMCW) of a plurality of FMCWs, or a first synchronization signal block (SSB) burst of a plurality of SSB bursts, the monitoring comprising sweeping across a plurality of frequency resources during a first set of time resources according to a duration in time of each FMCW of the plurality of FMCWs and a frequency range associated with each FMCW of the plurality of FMCWs; and
receiving at least one of the first FMCW or the first SSB burst based at least in part on the monitoring.

22. The method of claim 21, further comprising:
performing a primary synchronization based at least in part on receiving the first FMCW;
receiving the first SSB burst based at least in part on the primary synchronization; and
performing a secondary synchronization based at least in part on receiving the first SSB burst.

23. The method of claim 21, further comprising:
performing an FMCW mixing procedure based at least in part on the monitoring to generate a beat signal; and
performing one or more Fast Fourier Transforms on the beat signal to identify one or more peak locations in a frequency domain, the one or more peak locations corresponding to the first FMCW.

24. The method of claim 21, wherein the monitoring comprises:
sweeping across the plurality of frequency resources during a second set of time resources according to a slope value that is based at least in part on the duration in time of each FMCW of the plurality of FMCWs and the frequency range associated with each FMCW of the plurality of FMCWs.

25. The method of claim 24, wherein receiving the first FMCW comprises:
receiving a first instance of the first FMCW during the first set of time resources; and
receiving a second instance of the first FMCW during the second set of time resources.

26. The method of claim 21, further comprising:
receiving a first portion of the first FMCW during the first set of time resources;
adjusting a timing for monitoring for the plurality of FMCWs; and
sweeping across the plurality of frequency resources during a second set of time resources according to a slope value that is based at least in part on the duration in time of each FMCW of the plurality of FMCWs and a frequency range associated with each FMCW of the plurality of FMCWs, and based at least in part on the adjusted timing, wherein receiving the first FMCW is based at least in part on sweeping the frequency resources during the second set of time resources.

27. The method of claim 21, wherein the plurality of FMCWs are transmitted at a first periodicity, and the plurality of SSB bursts are transmitted at a second periodicity.

28. The method of claim 21, further comprising:
detecting, based at least in part on the monitoring, multiple FMCW beat frequencies; and
identifying a unique pattern in time and frequency based at least in part on the detecting, wherein receiving the first FMCW is based at least in part on the identifying.

29. The method of claim 21, further comprising:
detecting, based at least in part on the monitoring, a zero tail FMCW waveform having a duration that is less than an orthogonal frequency division multiplexing symbol, wherein receiving the first FMCW is based at least in part on the detecting.

30. (canceled)

31. A non-transitory computer-readable medium storing code for wireless communications, the code comprising instructions executable by one or more processors to:
monitor, according to a searching procedure, for at least one of a first frequency modulated continuous wave (FMCW) of a plurality of FMCWs, or a first synchronization signal block (SSB) burst of a plurality of SSB bursts, the monitoring comprising sweeping across a plurality of frequency resources during a first set of time resources according to a duration in time of each FMCW of the plurality of FMCWs and a frequency range associated with each FMCW of the plurality of FMCWs; and
receive at least one of the first FMCW or the first SSB burst based at least in part on the monitoring.

32. The non-transitory computer-readable medium of claim 31, wherein the instructions are further executable by the one or more processors to:
perform a primary synchronization based at least in part on receiving the first FMCW;
receive the first SSB burst based at least in part on the primary synchronization; and
perform a secondary synchronization based at least in part on receiving the first SSB burst.

33. The non-transitory computer-readable medium of claim 31, wherein the instructions are further executable by the one or more processors to:
perform an FMCW mixing procedure based at least in part on the monitoring to generate a beat signal; and
perform one or more Fast Fourier Transforms on the beat signal to identify one or more peak locations in a frequency domain, the one or more peak locations corresponding to the first FMCW.

34. The non-transitory computer-readable medium of claim 31, wherein, to monitor, the instructions are further executable by the one or more processors to:
sweep across the plurality of frequency resources during a second set of time resources according to a slope value that is based at least in part on the duration in time of each FMCW of the plurality of FMCWs and the frequency range associated with each FMCW of the plurality of FMCWs.

35. The non-transitory computer-readable medium of claim 34, wherein, to receive the first FMCW, the instructions are further executable by the one or more processors to:
receive a first instance of the first FMCW during the first set of time resources; and
receive a second instance of the first FMCW during the second set of time resources.

36. The non-transitory computer-readable medium of claim 31, wherein the instructions are further executable by the one or more processors to:
receive a first portion of the first FMCW during the first set of time resources;
adjust a timing for monitoring for the plurality of FMCWs; and
sweep across the plurality of frequency resources during a second set of time resources according to a slope value that is based at least in part on the duration in time of each FMCW of the plurality of FMCWs and a frequency range associated with each FMCW of the plurality of FMCWs, and based at least in part on the adjusted timing, wherein receiving the first FMCW is based at least in part on sweeping the frequency resources during the second set of time resources.

37. The non-transitory computer-readable medium of claim 31, wherein the plurality of FMCWs are transmitted at a first periodicity, and the plurality of SSB bursts are transmitted at a second periodicity.

38. The non-transitory computer-readable medium of claim 31, wherein the instructions are further executable by the one or more processors to:
detect, based at least in part on the monitoring, multiple FMCW beat frequencies; and
identify a unique pattern in time and frequency based at least in part on the detecting, wherein receiving the first FMCW is based at least in part on the identifying.

39. The non-transitory computer-readable medium of claim 31, wherein the instructions are further executable by the one or more processors to:
detect, based at least in part on the monitoring, a zero tail FMCW waveform having a duration that is less than an orthogonal frequency division multiplexing symbol, wherein receiving the first FMCW is based at least in part on the detecting.

40. A user equipment (UE) for wireless communications, comprising:
means for monitoring, according to a searching procedure, for at least one of a first frequency modulated continuous wave (FMCW) of a plurality of FMCWs, or a first synchronization signal block (SSB) burst of a plurality of SSB bursts, the monitoring comprising sweeping across a plurality of frequency resources during a first set of time resources according to a duration in time of each FMCW of the plurality of FMCWs and a frequency range associated with each FMCW of the plurality of FMCWs; and
means for receiving at least one of the first FMCW or the first SSB burst based at least in part on the monitoring.
